(19) United States
(12) Patent Application Publication
(10) Pub. No.: US 2017/0220450 A1
(43) Pub. Date: Aug. 3, 2017

(54) ANALYTIC METHOD AND ANALYZING APPARATUS

(71) Applicant: FUJITSU LIMITED, Kawasaki-shi (JP)

(72) Inventors: Susumu TOKUMOTO, Kawasaki (JP); Hiroaki Yoshida, Cupertino, CA (US)

(73) Assignee: FUJITSU LIMITED, Kawasaki (JP)

(21) Appl. No.: 15/009,268

(22) Filed: Jan. 28, 2016

(51) Int. Cl. G06F 11/36

(52) U.S. Cl. CPC G06F 11/3624; G06F 11/3612

(57) ABSTRACT

An analysis program recorded in a recording medium causes a computer to hold, when executing an intermediate code that is a compiled code in which an element in a source code is replaced with a metafunction that changes the element to a mutant, a set of mutation descriptors indicating a change in the mutant with respect to a mutation operation corresponding to the metafunction. The analysis program further causes the computer to evaluate a command of each of the mutation descriptors, select at least one mutation descriptor having a same command evaluation result from the set of the mutation descriptors, and calculate a direct product of the selected mutation descriptor and one of the mutation operation and a first state that is the set of the mutation descriptors before evaluation of the commands, thereby generating a second state. The analysis program further causes the computer to bundle, when evaluating a command of each mutation descriptor of the generated second state, if a plurality of the second states are present, the second states into a single group, evaluate commands of the second states in the group in parallel, and merge third states having the same evaluation result among third states that are based on the command evaluation results in the group.

### FIELD

The embodiment discussed herein is related to a recording medium in which an analysis program is recorded, an analytic method, and an analyzing apparatus.

### BACKGROUND

Conventionally, as a method of evaluating a test of software, a method called mutation analysis is known, in which one element of a program is changed to embed a bug and how well the test detects the embedded bug is investigated. In the mutation analysis, each source code subjected to mutation is compiled and executed to generate all sorts of mutants that are changed elements, so that it takes a long time to perform a process. Therefore, a technology has been proposed, in which an element is replaced with a metafunction that is a function representing a specific mutant when a parameter is given, instead of performing mutations by replacing an element with a plurality of mutants, in order to reduce compiling cost.

Furthermore, a technology has been proposed in the literature such as K. N. King and J. Offutt, “A Fortran Language System for Mutation-Based Software Testing”, Software-Practice and Experience, 1991., in which executions are performed while splitting states (hereinafter, also referred to as states) in which elements are replaced with respective mutants, in order to reduce calculation cost.

Moreover, a technology has been proposed in the literature such as Rene Just, et al., Efficient mutation analysis by propagating and partitioning infected execution states. ISSTA2014, in which mutants having the same execution result as an original execution result are eliminated and mutants having the same execution result with one another are bundled in order to reduce calculation cost.

Patent Literature 1: Japanese Laid-open Patent Publication No. 2009-181549

Patent Literature 2: Japanese Laid-open Patent Publication No. 8-044590

However, when the mutants having the same execution result are bundled, execution paths of the mutants may be changed from an original execution path. Therefore, for example, whether the state is equivalent when a loop is executed multiple times is not found out until the mutants are executed. That is, in some cases, it may be difficult to bundle mutants having the same execution result, and it may become difficult to reduce the number of states of a higher order mutation.

### SUMMARY

According to an aspect of an embodiment, an analysis program recorded in a recording medium causes a computer to hold, when executing an intermediate code that is a compiled code in which an element in a source code is replaced with a metafunction that changes the element to a mutant, a set of mutation descriptors indicating a change in the mutant with respect to a mutation operation corresponding to the metafunction. The analysis program further causes the computer to evaluate a command of each of the mutation descriptors, select at least one mutation descriptor having a same command evaluation result from the set of the mutation descriptors, and calculate a direct product of the selected mutation descriptor and one of the mutation operation and a first state that is the set of the mutation descriptors before evaluation of the commands, thereby generating a second state. The analysis program further causes the computer to bundle, when evaluating a command of each mutation descriptor of the generated second state, if a plurality of the second states are present, the second states into a single group, evaluate commands of the second states in the group in parallel, and merge third states having the same evaluation result among third states that are based on the command evaluation results in the group.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of a configuration of an analyzing apparatus according to an embodiment;

FIG. 2 is a diagram for explaining an example of mutation analysis;

FIG. 3 is a diagram for explaining an example of implemcntation cost of the mutation analysis;

FIG. 4 is a diagram for explaining an example of a method of execution while splitting a state;

FIG. 5 is a diagram for explaining an example of a method of reducing calculation cost;

FIG. 6 is a diagram for explaining an example of replacement of a mutated portion;

FIG. 7 is a diagram for explaining an example of mutant analysis;

FIG. 8 is a diagram for explaining an example of a case in which it is difficult to bundle mutants having the same execution result;

FIG. 9 is a diagram illustrating an example of a command storage unit;

FIG. 10 is a diagram illustrating an example of an evaluation result storage unit;

FIG. 11 is a diagram illustrating an example of an execution state set storage unit;

FIG. 12 is a diagram illustrating an example of a test result storage unit;

FIG. 13 is a diagram illustrating an example of a source code as a test target;

FIG. 14 is a diagram illustrating an example of a source code in which a metafunction is embedded;

FIG. 15 is a diagram illustrating an example of an intermediate code;

FIG. 16 is a diagram illustrating an example of a test item;

FIG. 17 is a diagram illustrating an example of a mutation operator list;

FIG. 18 is a flowchart illustrating an example of an analysis process according to the embodiment;

FIG. 19 is a flowchart illustrating an example of a state selecting process;

FIG. 20 is a flowchart illustrating an example of a state splitting process;

FIG. 21 is a flowchart illustrating an example of a state merging process;

FIG. 22 is a flowchart illustrating an example of a state completion checking process;

FIG. 23 is a diagram for explaining an example of a first while loop;

FIG. 24 is a diagram for explaining an example of the first while loop;

FIG. 25 is a diagram for explaining an example of the first while loop;

FIG. 26 is a diagram for explaining an example of the first while loop;

FIG. 27 is a diagram for explaining an example of the first while loop;

FIG. 28 is a diagram for explaining an example of the first while loop;

FIG. 29 is a diagram for explaining an example of the first while loop;

FIG. 30 is a diagram for explaining an example of the first while loop:

FIG. 31 is a diagram for explaining an example of a second while loop;

FIG. 32 is a diagram for explaining an example of the second while loop;

FIG. 33 is a diagram for explaining an example of the second while loop;

FIG. 34 is a diagram for explaining an example of the second while loop;

FIG. 35 is a diagram for explaining an example of the second while loop;

FIG. 36 is a diagram for explaining an example of the second while loop;

FIG. 37 is a diagram for explaining an example of the second while loop;

FIG. 38 is a diagram for explaining an example of a third while loop;

FIG. 39 is a diagram for explaining an example of the third while loop;

FIG. 40 is a diagram for explaining an example of a fourth while loop;

FIG. 41 is a diagram for explaining an example of the fourth while loop;

FIG. 42 is a diagram for explaining an example of a fifth while loop;

FIG. 43 is a diagram for explaining an example of the second while loop;

FIG. 44 is a diagram for explaining an example of the second while loop;

FIG. 45 is a diagram for explaining an example of the second while loop;

FIG. 46 is a diagram for explaining an example of the second while loop;

FIG. 47 is a diagram for explaining an example of assignment of each state; and

FIG. 48 is a diagram illustrating an example of a computer that executes an analysis program.

### DESCRIPTION OF EMBODIMENTS

Preferred embodiments of a recording medium in which an analysis program of the disclosed technology is recorded, an analytic method, and an analyzing apparatus will be described in detail below with reference to the accompanying drawings. The disclosed technology is not limited by the embodiments below. The embodiments below may be combined appropriately as long as no contradiction is derived.

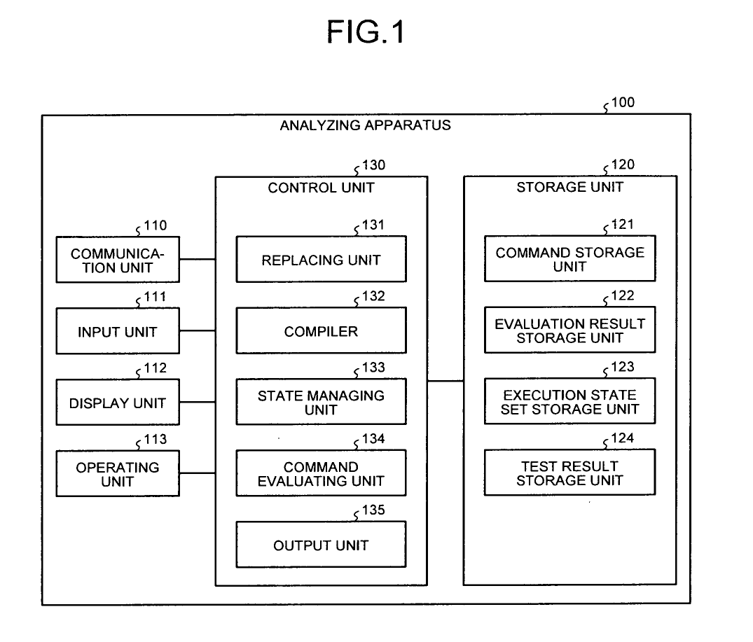

FIG. 1 is a block diagram illustrating an example of a configuration of an analyzing apparatus according to an embodiment. An analyzing apparatus 100 illustrated in FIG. 1, when executing an intermediate code that is a compiled code in which an element in a source code is replaced with a metafunction that changes the element to a mutant, holds a set of mutation descriptors indicating a change in the mutant with respect to a mutation operation corresponding to the metafunction. The analyzing apparatus 100 evaluates a command of each of the mutation descriptors. The analyzing apparatus 100 selects one or more mutation descriptors having the same command evaluation result from the set of the mutation descriptors. The analyzing apparatus 100 calculates a direct product of the selected mutation descriptor and the mutation operation or a first state that is the set of the mutation descriptors before evaluation of the commands, thereby generating a second state. The analyzing apparatus 100, when evaluating a command of each mutation descriptor of the generated second state, if a plurality of the second states are present, bundles the second states into a single group and evaluates commands of the respective second states in the group in parallel. The analyzing apparatus 100 merges third states having the same evaluation result among third states that are based on the command evaluation results in the group. Consequently, the analyzing apparatus 100 can reduce the number of states of a higher order mutation.

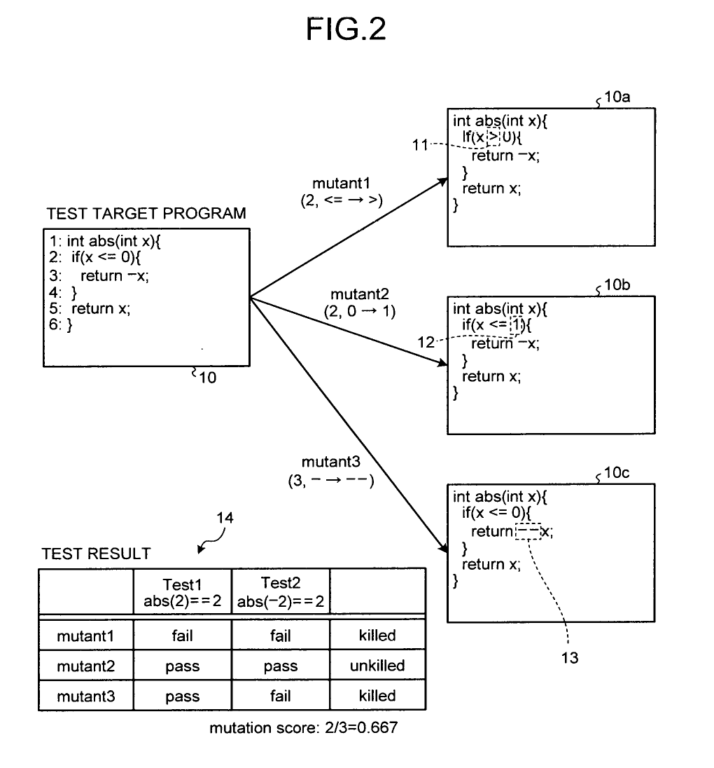

Mutation analysis will be described below. FIG. 2 is a diagram for explaining an example of the mutation analysis. As illustrated in FIG. 2, in the mutation analysis, a mutation is performed on an element of a source code 10 that is a test target program. A source code 10a is a source code obtained by performing, for example, a mutation indicated by “mutant1” on the source code 10. For example, “mutant1” changes “<=” in the second line to “>”. That is, in the source code 10a, a portion indicated by a mutated portion 11 is changed as compared to the source code 10.

Similarly, a source code 10b is a source code obtained by performing, for example, a mutation indicated by “mutant1” on the source code 10. For example, “mutant2” changes “0” in the second line to “1”. That is, in the source code 10b, a portion indicated by a mutated portion 12 is changed as compared to the source code 10. Similarly, a source code 10c is a source code obtained by performing, for example, a mutation indicated by “mutant3” on the source code 10. For example, “mutant3” changes “-” in the third line to “--”. That is, in the source code 10c, a portion indicated by a mutated portion 13 is changed as compared to the source code 10.

A test result 14 is a result obtained by performing a certain test on the mutated source codes 10a to 10c. For example, in “Test1”, “pass” is given when “2” is input to “abs” and “2” is output, and “fail” is given when other than “2” is output. Furthermore, for example, in “Test2”, “pass” is given when “−2” is input to “abs” and “2” is output, and “fail” is given when other than “2” is output. In this case, results of “mutant1” to “mutant3” are obtained as indicated in the test result 14.

As for “mutant1”, “fail” is given in each of “Test1” and “Test2”, so that it is possible to detect the embedded bug; therefore, “killed” is given. As for “mutant2”, “pass” is given in each of “Test1” and “Test2”, so that it is impossible to detect the embedded bug; therefore, “unkilled” is given. As for “mutant3”, “pass” is given in “Test1” and “fail” is given in “Test2”, so that it is possible to detect the embedded bug; therefore, “killed” is given. As a result, a mutation score indicating the ratio of mutants that are “killed” is 2/3=0.667.

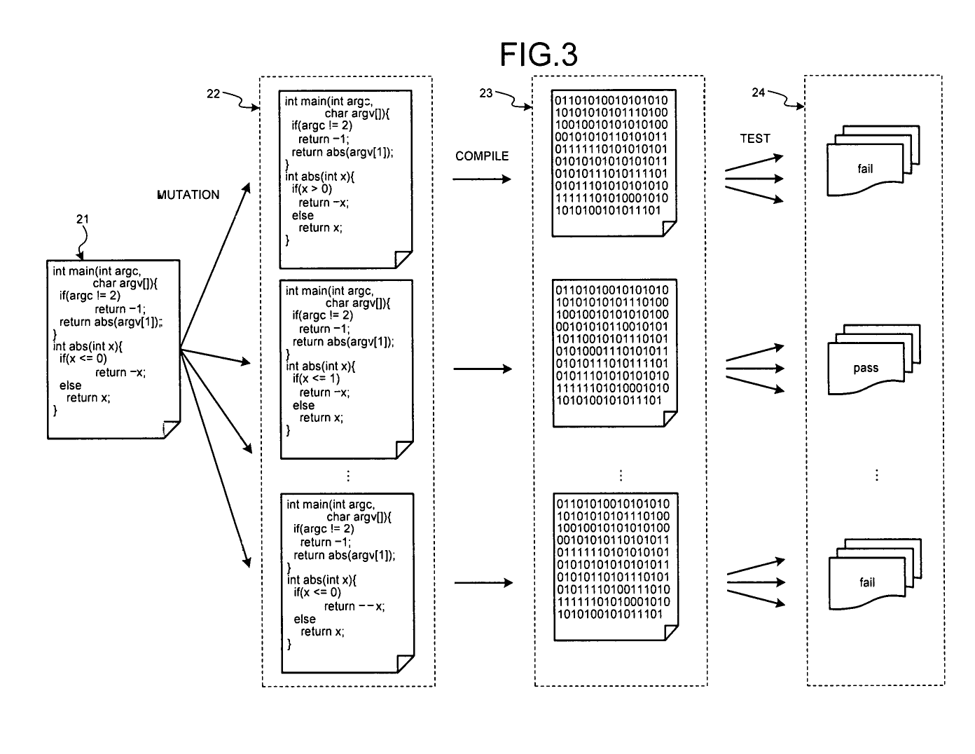

Next, implementation cost of the mutation analysis will be described. FIG. 3 is a diagram for explaining an example of the implementation cost of the mutation analysis. As illustrated in FIG. 3, in the mutation analysis, an execution file group 23 is generated by compiling a source code group 22 in which a source code 21 is mutated. In addition, in the mutation analysis, tests are performed on the generated execution file group 23 and a test result group 24 is obtained. An execution time of the mutation analysis at this time is obtained such that a total time=(the number of mutants)×(mutation time+compile time) +(the number of mutants)×(the number of test items)×(execution time per execution). That is, the execution time of the mutation analysis illustrated in FIG. 3 is long because all sorts of mutants are generated.

In contrast, for example, in Mutant Schema Generation (MSG), an element of the source code is replaced with a metafunction that is a function representing a specific mutant when a parameter is given, in order to reduce compiling cost. Furthermore, Split-Stream Execution has been proposed, in which executions are performed while splitting states in which elements are replaced with respective mutants, in order to reduce calculation cost.

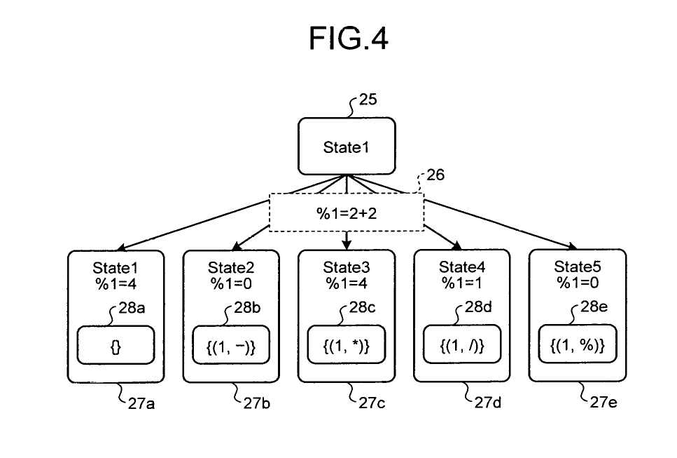

FIG. 4 is a diagram for explaining an example of a method of execution while splitting a state. In the example in FIG. 4, a mutation is performed on a command 26 of “%1=2+2”. In the example in FIG. 4, an operator “+” is mutated when the command 26 is executed on a state 25 indicated by “State1”. In the example in FIG. 4, the state is split into five states such as a state 27a indicated by “State1”, a state 27b indicated by “State2”, a state 27c indicated by “State3”, a state 27d indicated by “State4”, and a state 27e indicated by “State5”.

In the state 27a, the operator “+” in the command 26 is used as it is, so that a calculation result of the command 26 is “%1=4”. A mutation descriptor 28a of the state 27a is “{}”. In the state 27b, the operator in the command 26 is mutated to “−”, so that a calculation result of the command 26 is “%1=0”. A mutation descriptor 28b of the state 27b is “{(1, −)}”. Meanwhile, the mutation descriptor 28b is represented by a pair of a mutation identifier (ID) of “1” indicating a mutated portion and a changed content “−”, and the same applies to the mutation descriptors described below.

In the state 27c, the operator in the command 26 is mutated to “*”, so that a calculation result of the command 26 is “%1=4”. A mutation descriptor 28c of the state 27c is “{(1, *)}”. In the state 27d, the operator in the command 26 is mutated to “/”, so that a calculation result of the command 26 is “%1=1”. A mutation descriptor 28d of the state 27d is “{(1, /)}”. In the state 27e, the operator in the command 26 is mutated to “%”, so that a calculation result of the command 26 is “%1=0”. A mutation descriptor 28e of the state 27e is “{(1, %)}”.

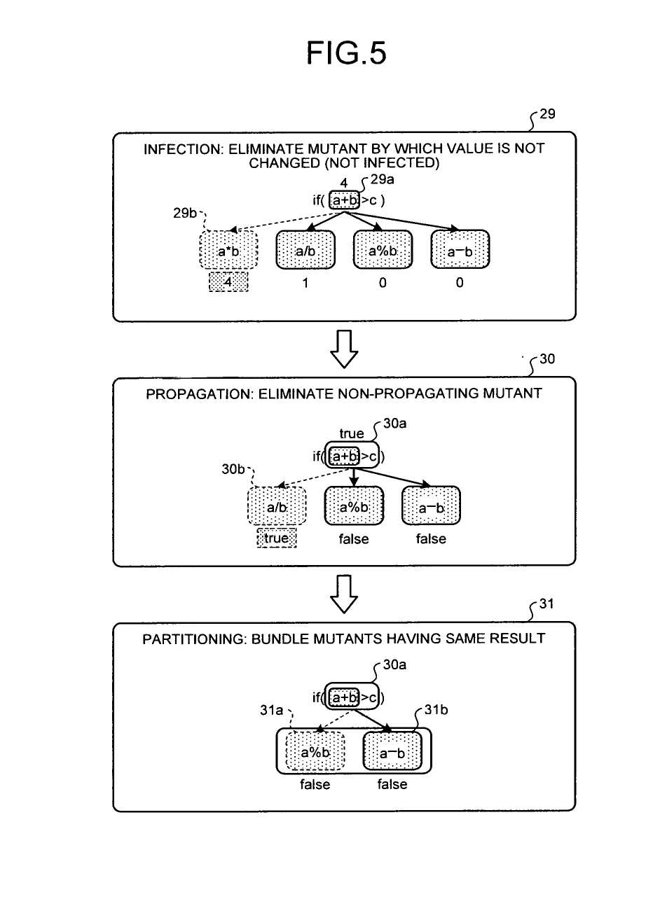

A method of eliminating mutants having the same execution result as an original execution result and bundling mutants having the same execution result with one another will be described below with reference to FIG. 5. FIG. 5 is a diagram for explaining an example of a method of reducing the calculation cost. The method illustrated in FIG. 5 is called Mutants filtering with dynamic analysis. In the example in FIG. 5, the calculation cost is reduced by infection 29, propagation 30, and partitioning 31 in this order. In the infection 29, a mutant by which a value is not changed, that is, a mutant that is not infected is eliminated. In the example in FIG. 5, assuming that test inputs are a=2, b=2, and c=0, an expression 29a in an original command is given as a+b=2+2=4. In the infection 29, when the operator “+” is mutated to “*”, “/”, “%”, and “−”, an expression 29b in which the operator is mutated to “*” gives “4” that is the same as the expression 29a, so that the mutant of the operator “*” is eliminated.

Subsequently, in the propagation 30, a mutant that does not propagate is eliminated. In the example in FIG. 5, an expression 30a in the original command is given as a+b>c, that is, 2+2>0, so that “true” is given. In the propagation 30, when the operator “+” is mutated to “/”, “%”, and “−”, and if an expression 30b in which the operator in the expression 30a is mutated to “/” is included, “true” is given, which is the same as the expression 30a with the operator “+”. Therefore, the mutant of the operator “/” is eliminated.

Subsequently, in the partitioning 31, mutants having the same result are bundled. In the example in FIG. 5, when the operator “+” in the expression 30a is mutated to “%” and “−”, “false” is given in each case, so that it is possible to bundle an expression 31a and an expression 31b.

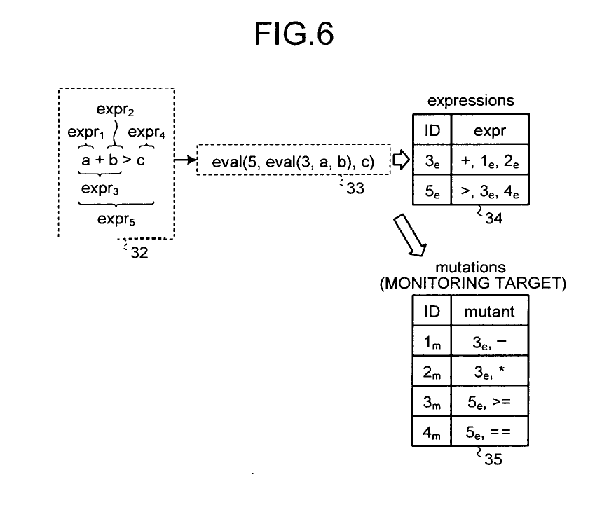

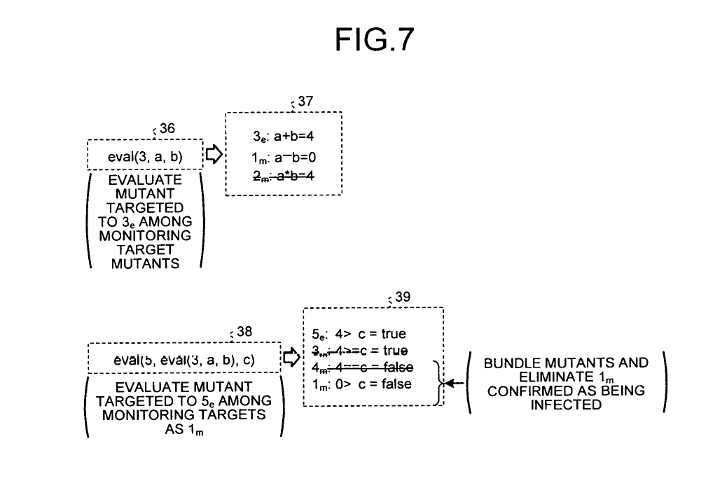

The method in FIG. 5 includes an execution flow with four steps. The execution flow with the four steps will be described below with reference to FIG. 6 and FIG. 7. FIG. 6 is a diagram for explaining an example of replacement of a mutated portion. As illustrated in FIG. 6, the first step is to replace mutated portions of a target program with eval method calls and generate two maps based on IDs. In the example in FIG. 6, as for an expression 32 including mutated portions, “a” is replaced with expr₁, “b” is replaced with expr₂, “a+b” is replaced with expr₃, “c” is replaced with expr₄, “a+b>c” is replaced with expr₅.

An expression 33 is an expression in which the mutated portions are replaced with the eval method calls. A table 34 indicates elements included in each of an ID “3ₑ” corresponding to expr₃ and an ID “5ₑ” corresponding to expr₅. A table 35 is a table indicating what mutation is possible, that is, a table indicating a monitoring target. For example, it is indicated that an ID “1ₘ” changes “+” to “−” with respect to the ID “3ₑ”. Furthermore, for example, it is indicated that an ID “3ₘ” changes “>” to “>=” with respect to the ID “5ₑ”.

FIG. 7 is a diagram for explaining an example of a mutant analysis. As illustrated in FIG. 7, the second step is to execute a test with the replaced program and analyze needed mutants. In the example in FIG. 7, mutants targeted to “3ₑ” among monitoring target mutants in an expression 36 are first analyzed. In an analysis result 37, a result of “2ₘ” is “4”, which is the same as a result of “3ₑ”, so that “2ₘ” is eliminated.

Subsequently, in the example in FIG. 7, mutants targeted to “5ₑ” and propagating mutants with “1ₘ” among monitoring target mutants in an expression 38 are analyzed. In an analysis result 39, a result of “3ₘ” is “true”, which is the same as a result of “5ₑ”, so that “3ₘ” is eliminated. Similarly, in the analysis result 39, a result of “4ₘ” is “false”, which is the same as a result of “1ₘ”, so that “4ₘ” and “1ₘ” are bundled together and “1ₘ” that is confirmed as being infected is eliminated from the monitoring targets. Meanwhile, “4ₘ” and “1ₘ” can be bundled on either side.

The third step is to embed the mutants in the original program. The fourth step is to execute a test on each of the mutants. That is, in FIG. 6 and FIG. 7, mutants are reduced at the first and the second steps, and mutations are performed at the third and the fourth steps. However, in the method of reducing the calculation cost as described above, the mutants are not executed at the second step. Therefore, it is difficult to reduce the number of states of a higher order mutation.

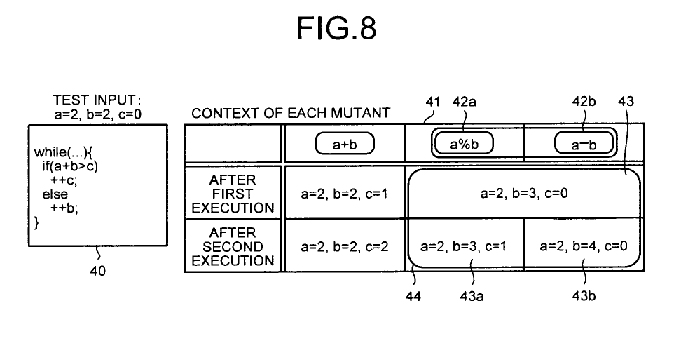

FIG. 8 is a diagram for explaining an example of a case in which it is difficult to bundle mutants having the same execution result. In the example in FIG. 8, there are cases in which contexts of respective mutants are different when test inputs in a source code 40 are a=2, b=2, and c=0. A table 41 indicates the contexts of the respective mutants after the first and the second executions of the source code 40. An expression 42a and an expression 42b give a same result 43 after the first execution, and are determined as the same partition. However, the expression 42a and the expression 42b give different results such as a result 43a and a result 43b after the second execution, and are determined as different partitions. That is, a result indicated by a range 44 is unclear until the mutants are executed.

Furthermore, if the method of executions while splitting a state is applied as it is to the method of reducing the calculation cost, wasteful state splitting is increased. To split a state, a copy process, which is a heavy process, is included; therefore, it is preferable to reduce state splitting as much as possible.

To cope with the issue as described above, in the embodiment, commands in a source code are first evaluated, and states are bundled based on command evaluation results, so that it is possible to reduce the number of states of a higher order mutation.

Referring back to FIG. 1, a configuration of the analyzing apparatus 100 will be described below. As illustrated in FIG. 1, the analyzing apparatus 100 includes a communication unit 110, an input unit 111, a display unit 112, an operating unit 113, a storage unit 120, and a control unit 130. The analyzing apparatus 100 may include various functional units included in a known computer, for example, functional units such as various input devices and voice output devices, in addition to the functional units illustrated in FIG. 1.

The communication unit 110 is implemented by, for example, a network interface card (NIC) or the like. The communication unit 110 is a communication interface that is connected to other information processing apparatuses through a network (not illustrated) by wire or wireless, and controls communication of information with the other information processing apparatus. For example, the communication unit 110 receives, from the other information processing apparatuses, an analysis target source code, a test item, and a mutation operator list. The communication unit 110 outputs the received analysis target source code, the received test item, and the received mutation operator list to the control unit 130.

The input unit 111 is implemented by, for example, a media access device or the like for an external storage medium, such as an optical disk, a universal serial bus (USB) memory , or an SD memory card. The input unit 111 reads the analysis target source code, the test item, and the mutation operator list that are stored in the external storage medium, and outputs the read analysis target source code, the read test item, and the read mutation operator list to the control unit 130. Meanwhile, it is sufficient that the analysis target source code, the test item, and the mutation operator list are input to the control unit 130 from any of the communication unit 110 and the input unit 111, and in the following description, a case will be described in which they are input from the input unit 111 to the control unit 130.

The display unit 112 is a display device for displaying various kinds of information. The display unit 112 is implemented by, for example, a liquid crystal display or the like as the display device. The display unit 112 displays various screens, such as a result screen input from the control unit 130.

The operating unit 113 is an input device that accepts various operations from a user of the analyzing apparatus 100. The operating unit 113 is implemented by, for example, a keyboard, a mouse, or the like as an input device. The operating unit 113 outputs an operation input by the user as operation information to the control unit 130. The operating unit 113 may be implemented by a touch panel or the like as the input device. The display device of the display unit 112 and the input device of the operating unit 113 may be integrated with each other.

The storage unit 120 is implemented by, for example, a semiconductor memory device, such as a random access memory (RAM) or a flash memory, or a storage device, such as a hard disk or an optical disk. The storage unit 120 includes a command storage unit 121, an evaluation result storage unit 122, an execution state set storage unit 123, and a test result storage unit 124. Furthermore, the storage unit 120 stores therein information used for a process performed by the control unit 130.

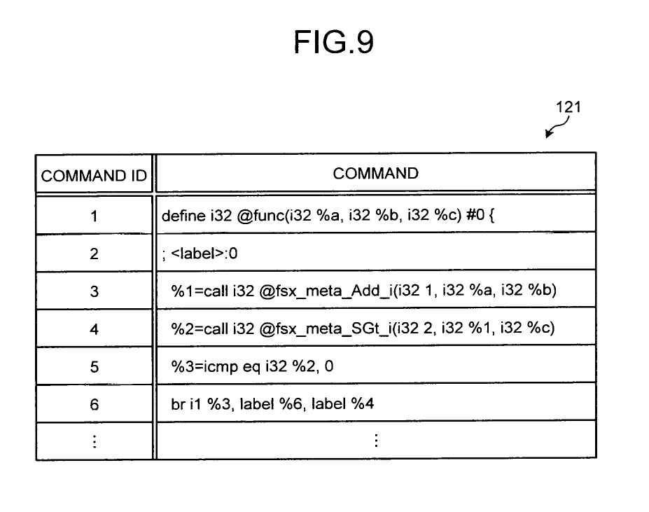

The command storage unit 121 stores therein each command of an intermediate code in which a source code is compiled, in association with a command ID. The intermediate code may be, for example, a bit code. FIG. 9 is a diagram illustrating an example of the command storage unit. As illustrated in FIG. 9, the command storage unit 121 includes items such as “command ID” and “command”. The command storage unit 121 stores therein, for example, a single record for each command ID.

The “command ID” is a number (ID) uniquely assigned to each command, and an identifier for identifying the command. The “command” is information indicating each command of an intermediate code.

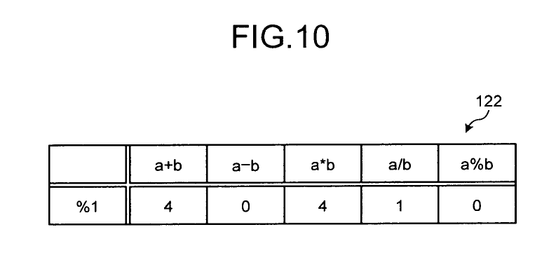

Referring back to FIG. 1, the evaluation result storage unit 122 stores therein an evaluation result of each mutant that has been mutated. FIG. 10 is a diagram illustrating an example of the evaluation result storage unit. As illustrated in FIG. 10, for example, the evaluation result storage unit 122 stores therein an evaluation result of each mutant described using a mutation descriptor, in association with “%1” indicating a register in which a result of a command is stored. The evaluation result storage unit 122 is updated in accordance with the mutation descriptors every time a command to be evaluated is changed.

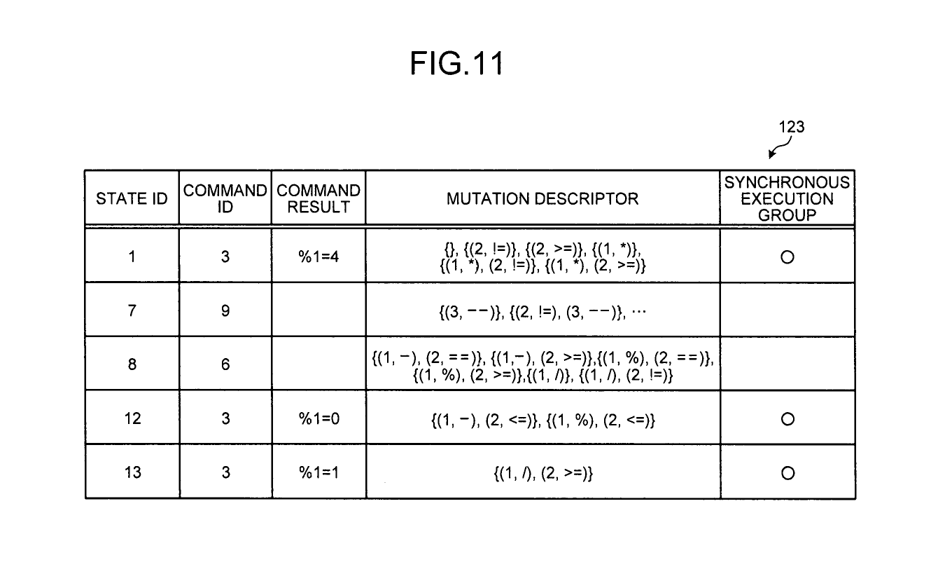

Referring back to FIG. 1, the execution state set storage unit 123 stores therein a mutation descriptor of each command and an evaluation result, in association with a state ID. That is, the execution state set storage unit 123 stores therein an execution state set. FIG. 11 is a diagram illustrating an example of the execution state set storage unit. As illustrated in FIG. 11, the execution state set storage unit 123 includes items such as “state ID”, “command ID”, “command result”, “mutation descriptor”, and “synchronous execution group”. The execution state set storage unit 123 stores therein, for example, a single record for each state ID.

The “state ID” is an identifier for identifying an execution state, that is, a state. The “state ID” may be taken over by a state obtained by evaluation of a command. The “command ID” an identifier for identifying a command. The “command result” is information indicating a command evaluation result, that is, an execution result. The “mutation descriptor” is information indicating a mutation descriptor of a command for a corresponding state ID. The “synchronous execution group” is information indicating a group for evaluating commands of a plurality of states in parallel. In the “synchronous execution group”, for example, circle marks are provided to the state IDs being evaluated in parallel, so that it is possible to identify the state IDs being evaluated in parallel.

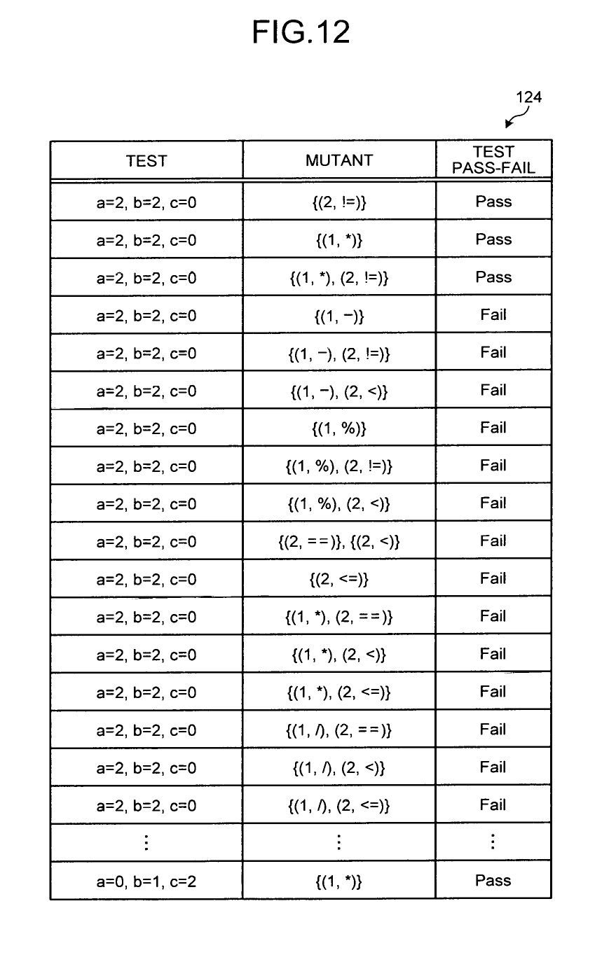

Referring back to FIG. 1, the test result storage unit 124 stores therein test results as results of execution of tests on mutated source codes, that is, a test result group. FIG. 12 is a diagram illustrating an example of the test result storage unit. As illustrated in FIG. 12, the test result storage unit 124 includes items such as “test”, “mutant”, and “test pass-fail”. The test result storage unit 124 stores therein a single record for each test item.

The “test” is information indicating test inputs with respect to a command. The “mutant” is information indicating a mutant with respect to the command. The “mutant” is described using a mutation descriptor, such as “{(2, !=)}”. The “test pass-fail” is information indicating pass or fail of a test on a mutation of a test target source code, and is represented by “Pass” or “Fail”. “Pass” indicates that a bug embedded in a test item is not detected when an element in the source code is replaced with a mutant. “Fail” indicates that a bug embedded in a test item is detected when an element in the source code is replaced with a mutant. In the example in the first line in FIG. 12, when a mutation is performed such that an element (operator) corresponding to a mutation ID “2” is mutated to “!=” with respect to test inputs of “a=2, b=2, c=0”, “Pass” is given in the test pass-fail, which indicates that the embedded bug is not detected.

Referring back to FIG. 1, the control unit 130 is implemented by, for example, executing a program stored in an internal storage device by a central processing unit (CPU), a micro processing unit (MPU), or the like by using a RAM as a work area. Furthermore, the control unit 130 may be implemented by, for example, an integrated circuit, such as an application specific integrated circuit (ASIC) or a field programmable gate array (FPGA). The control unit 130 includes a replacing unit 131, a compiler 132, a state managing unit 133, a command evaluating unit 134, and an output unit 135, and implements or executes functions and operations of information processing as described below. Incidentally, the internal configuration of the control unit 130 is not limited to the configuration as illustrated in FIG. 1, and any other configuration that performs the information processing as described below is applicable.

The replacing unit 131, when a source code is input from the input unit 111, replaces an element in the source code with a metafunction that changes the element to a mutant. The metafunction has the mutation ID as a parameter. The replacing unit 131 outputs a source code, in which the element in the source code is replaced with the metafunction, that is, the replaced source code in which the metafunction is embedded, to the compiler 132.

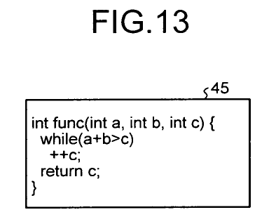

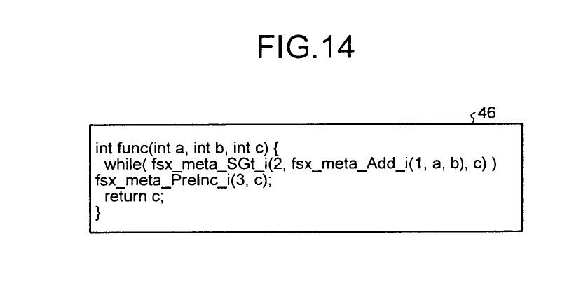

Embedding of the metafunction will be described below with reference to FIG. 13 and FIG. 14. FIG. 13 is a diagram illustrating an example of a test target source code. FIG. 14 is a diagram illustrating an example of a source code in which a metafunction is embedded. For example, the replacing unit 131 embeds metafunctions corresponding to operators “+” and “>” in a while statement in the second line and an operator “++” indicating increment in the third line in a source code 45 illustrated in FIG. 13. The replacing unit 131 generates a replaced source code 46 as illustrated in FIG. 14 by embedding the metafunctions in the source code 45.

Referring back to FIG. 1, when the replaced source code is input from the replacing unit 131, the compiler 132 compiles the replaced source code into a bit code that is an intermediate code executable on a virtual machine (VM). For example, the compiler 132 compiles the replaced source code into an LLVM bit code. In the following description, the LLVM bit code is simply referred to as an intermediate code. The compiler 132 outputs the compiled intermediate code to the state managing unit 133.

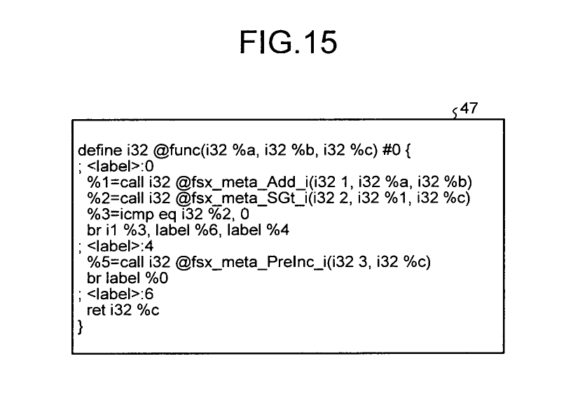

The intermediate code will be described below with reference to FIG. 15. FIG. 15 is a diagram illustrating an example of the intermediate code. As illustrated in FIG. 15, for example, the compiler 132 compiles the replaced source code into an intermediate code 47 that is an LLVM bit code. In the intermediate code 47 illustrated in FIG. 15, commands including the metafunctions embedded in FIG. 14 are compiled.

Referring back to FIG. 1, the state managing unit 133 receives an input of a test item and a mutation operator list from the input unit 111. Furthermore, the state managing unit 133 receives an input of the intermediate code from the compiler 132. The state managing unit 133, when the intermediate code is input, selects a test input, that is, a test case, on the basis of the test item and the mutation operator list. The test case may be, for example, “a=2, b=2, c=0” or the like.

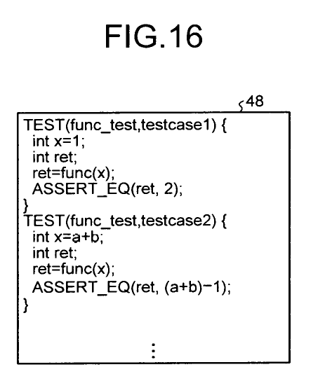

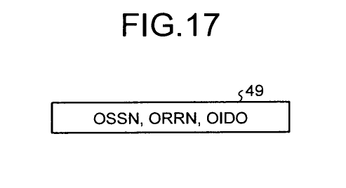

The test item and the mutation operator list will be described below with reference to FIG. 16 and FIG. 17. FIG. 16 is a diagram illustrating an example of the test item. FIG. 17 is a diagram illustrating an example of the mutation operator list. As illustrated in FIG. 16, for example, in a test item 48, each test item is represented in the form of a function. Furthermore, as illustrated in FIG. 17, for example, a mutation operator list 49 is represented in the form of OSSN (Shift operator mutation), ORRN (Relation operator mutation), OIDO (Increment/Decrement Replacement), and the like.

The state managing unit 133, upon selecting the test case, generates an initial execution state. The state managing unit 133, upon generating the initial execution state, performs a state selecting process. As the state selecting process, the state managing unit 133 first refers to the execution state set storage unit 123, and determines whether a state that is included in a synchronous execution group (hereinafter, may be simply referred to as a group) is present in an execution state set. If the state included in the group is not present, the state managing unit 133 selects a state by an arbitrary method, for example, selects a state by giving priority to depth, and ends the state selecting process.

If the state included in the group is present, the state managing unit 133 determines whether the group includes states in which a command being evaluated is not executed. If the group includes the states in which the command being evaluated is not executed, the state managing unit 133 selects one arbitrary state from the states in which the command being evaluated is not executed in the group, and ends the state selecting process. If the group does not include the states in which the command being evaluated is not executed, the state managing unit 133 takes a next command as being evaluated, selects a state in which the next command is not executed, and ends the state selecting process. When the state selecting process ends, the state managing unit 133 outputs a state ID of the selected state to the command evaluating unit 134.

The state managing unit 133, when a group dissolution instruction is input from the command evaluating unit 134, deletes the field of the synchronous execution group in the execution state set storage unit 123 and dissolves the group. The state managing unit 133, when the group is dissolved, outputs dissolution completion information to the command evaluating unit 134.

The state managing unit 133, when a state split instruction is input from the command evaluating unit 134, performs a state splitting process. As the state splitting process, the state managing unit 133 first determines whether a metafunction has been executed in a state corresponding to the state split instruction. In the case of the executed metafunction, the state managing unit 133 stores a set M, in which mutation operations corresponding to the metafunction are bundled, that is, mutation descriptors used for the mutation operations among mutation descriptors of an original state, in the execution state set storage unit 123 in association with the state ID. The state managing unit 133, upon storing the set M in association with the state ID in the execution state set storage unit 123, outputs an evaluation instruction to the command evaluating unit 134.

In the case of not being the executed metafunction, the state managing unit 133 stores the set M of the mutation operations corresponding to the metafunction, that is, the mutation descriptors used for the mutation operations, in the execution state set storage unit 123 in association with the state ID. The state managing unit 133, upon storing the set M in association with the state ID in the execution state set storage unit 123, outputs an evaluation instruction to the command evaluating unit 134.

The state managing unit 133, when a group determination instruction is input from the command evaluating unit 134, refers to the execution state set storage unit 123 and determines whether a state before the split belongs to a group. If the state before the split belongs to the group, the state managing unit 133 includes a state after the split in the group before the split. That is, the state managing unit 133 stores circle marks in the field of the synchronous execution group for corresponding states in the execution state set storage unit 123. The state managing unit 133, upon classifying the split state into the group, ends the state splitting process.

If the state before the split does not belong to a group, the state managing unit 133 generates a new group and includes the state after the split in the generated group. That is, the state managing unit 133 stores circle marks in the field of the synchronous execution group for the state after the split in the execution state set storage unit 123. The state managing unit 133, upon classifying the split state into the group, ends the state splitting process.

The state managing unit 133, when the state splitting process ends or when command execution information is input from the command evaluating unit 134, determines whether the state is included in a group and whether the same command has been executed in all of states in the group. If the state is included in the group and the same command has been executed in all of the states in the group, the state managing unit 133 performs a state merging process. If the state is included in the group and the same command has not been executed in all of the states in the group, the state managing unit 133 performs a state completion checking process.

As the state merging process, the state managing unit 133 first determines whether the states in the group have the same evaluation result. If the states in the group have the same evaluation result, the state managing unit 133 ends the state merging process. If the states in the group do not have the same evaluation result, the state managing unit 133 performs merging of a state s in the group. The state managing unit 133 determines whether a different state having the same evaluation result is present in the group. If a different state having the same evaluation result is present in the group, the state managing unit 133 adds a mutation descriptor of the state s to the state having the same evaluation result, and deletes the state s. If a different state having the same evaluation result is not present in the group, the state managing unit 133 performs merging of a next state. The state managing unit 133, upon completing the merging of the state s in the group, ends the state merging process and subsequently performs the state completion checking process.

As the state completion checking process, the state managing unit 133 first determines whether a program has reached the end. If the program has reached the end, the state managing unit 133 refers to the execution state set storage unit 123, stores a test result in the test result storage unit 124, deletes the states in the execution state set storage unit 123, and ends the state completion checking process. That is, the state managing unit 133 clears the execution state set storage unit 123 in which information on the states related to the selected test case has been stored.

If the program has not reached the end, the state managing unit 133 determines whether a termination condition specified by the user is exceeded. If the termination condition specified by the user is exceeded, the state managing unit 133 refers to the execution state set storage unit 123, stores a test result in the test result storage unit 124, deletes the states in the execution state set storage unit 123, and ends the state completion checking process. If the termination condition specified by the user is not exceeded, the state managing unit 133 determines whether an abnormality, such as an unauthorized access to a memory, has occurred.

If an abnormality has occurred, the state managing unit 133 refers to the execution state set storage unit 123, stores a test result in the test result storage unit 124, deletes the states in the execution state set storage unit 123, and ends the state completion checking process. If an abnormality has not occurred, the state managing unit 133 ends the state completion checking process.

The state managing unit 133, upon ending the state completion checking process, determines whether all of the states are completed. If all of the states are not completed, the state managing unit 133 performs the state selecting process. If all of the states are completed, the state managing unit 133 determines whether all of test cases have been executed. If all of the test cases have not been executed, the state managing unit 133 selects a next case and repeats the process by using the selected test case. If all of the test cases have been executed, the state managing unit 133 outputs an output instruction to the output unit 135.

As described above, the state managing unit 133 is an example of a managing unit that, when executing an intermediate code that is a compiled code in which an element in a source code is replaced with a metafunction that changes the element to a mutant, manages a set of mutation descriptors indicating a change in the mutant with respect to a mutation operation corresponding to the metafunction. Furthermore, the state managing unit 133 is an example of a selecting unit that selects one or more mutation descriptors having the same command evaluation result from the set of the mutation descriptors. Moreover, the state managing unit 133 is an example of a merging unit that merges third states having the same evaluation result among third states that are based on the command evaluation results in the group. Furthermore, the state managing unit 133 is an example of a merging unit that merges third states in the group while commands without adverse effects are continued. Moreover, the state managing unit 133 is an example of a merging unit that does not perform merging when a state returns to the first state or the second state through merging.

The command evaluating unit 134, when the state ID is input from the state managing unit 133, refers to the command storage unit 121 and the execution state set storage unit 123 and reads a command. The command evaluating unit 134, upon reading the command, determines whether a state indicated by the state ID is included in a group and the command is other than a command without an adverse effect. Meanwhile, the command without an adverse effect is a command that does not change a content of a memory, such as a specified metafunction (function except for increment/decrement), a binary operation (ADD, OR, or the like), a comparison operation (ICMP or FCMP), a conversion operation (Trunc, ZEXT, or the like), a read statement (load), or a getelementptr instruction. In contrast, a command that may cause an adverse effect may be, for example, a branch instruction, a function call, a return command (return), substitution for a variable, or the like. Furthermore, the command that may cause an adverse effect is, for example, a command that changes a value of a global variable.

If the state is included in a group and the command is other than the command without an adverse effect, the command evaluating unit 134 outputs a group dissolution instruction to the state managing unit 133. If the state is included in the group and the command is not other than the command without an adverse effect or if dissolution completion information is input from the state managing unit 133, the command evaluating unit 134 determines whether the command is a call for the metafunction. If the command is not a call for the metafunction, the command evaluating unit 134 executes the command and outputs command execution information to the state managing unit 133.

If the command is a call for the metafunction, the command evaluating unit 134 determines whether the metafunction is included in the mutation operator list. If the metafunction is not included in the mutation operator list, the command evaluating unit 134 executes the command and outputs command execution information to the state managing unit 133. If the metafunction is included in the mutation operator list, the command evaluating unit 134 outputs a state split instruction to the state managing unit 133.

The command evaluating unit 134, when the evaluation instruction is input from the state managing unit 133, refers to the command storage unit 121 and the execution state set storage unit 123 and performs an eager evaluation on mutation operations m in the set M. The command evaluating unit 134 stores command evaluation results of the mutation operations m in the evaluation result storage unit 122. The command evaluating unit 134 determines whether a state that already has the same evaluation result is present. If a state that already has the same evaluation result is present, the command evaluating unit 134 copies an original state, stores the evaluation result in the state, and selects the state. That is, the command evaluating unit 134 updates a record corresponding to the state ID of the state in the execution state set storage unit 123.

If a state that already has the same evaluation result is not present, the command evaluating unit 134 generates a state that has the same evaluation result and selects the state. Furthermore, the command evaluating unit 134 stores the generated state in the execution state set storage unit 123. That is, the command evaluating unit 134 splits the state.

The command evaluating unit 134 calculates direct products of the mutation operations m and the mutation descriptor of the original state, and adds the direct products to a mutation descriptor of the selected state, thereby updating the execution state set storage unit 123. The command evaluating unit 134 performs an eager evaluation, determination of the need of state splitting, and a calculation of the direct product with respect to each of the mutation operations m in the set M. The command evaluating unit 134, upon completing the eager evaluation, the determination of the need of state splitting, and the calculation of the direct product with respect to each of the mutation operations m in the set M, outputs a group determination instruction to the state managing unit 133.

As described above, the command evaluating unit 134 is an example of a first evaluating unit that evaluates a command of each of mutation descriptors. Furthermore, the command evaluating unit 134 is an example of a generating unit that calculates a direct product of a selected mutation descriptor and a mutation operation or a first state that is a set of the mutation descriptors before evaluation of the commands, thereby generating a second state. A part of the process performed by the generating unit may be performed by the state managing unit 133. Moreover, the command evaluating unit 134 is an example of a second evaluating unit that, when evaluating a command of each mutation descriptor of the generated second state, if a plurality of the second states are present, bundles the second states into a single group and evaluates commands of the respective second states in the group in parallel. Furthermore, the command evaluating unit 134 is an example of the second evaluating unit that dissolves the group and evaluates the commands of the second states when a command other than a command without an adverse effect appears.

The output unit 135, when the output instruction is input from the state managing unit 133, refers to the test result storage unit 124 and extracts mutants with “Pass” in the item of the test pass-fail. Furthermore, the output unit 135 calculates, as a mutation score, a value by dividing the number of mutants with “Fail” in the item of the test pass-fail in the test result storage unit 124 by the total number of mutants. The output unit 135 generates a result report based on the calculated mutation score and the mutants with “Pass” in the item of the test pass-fail. The output unit 135 generates a result screen including the result report, and outputs and displays the generated result screen to the display unit 112.

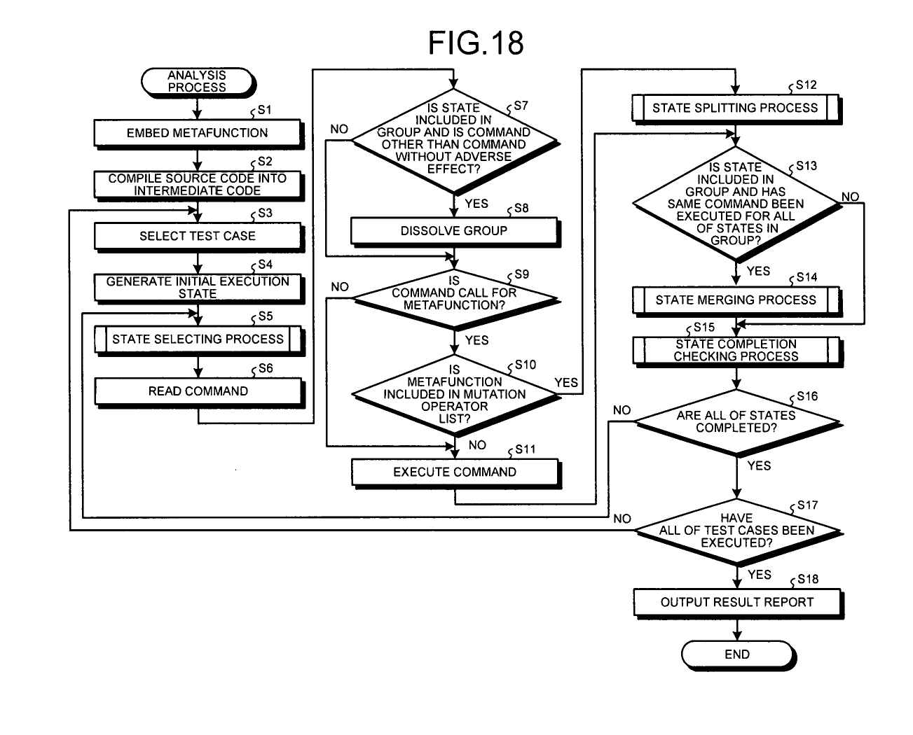

Next, operation performed by the analyzing apparatus 100 of the embodiment will be described. FIG. 18 is a flowchart illustrating an example of the analysis process of the embodiment.

The replacing unit 131, when a source code is input from the input unit 111, replaces an element in the source code with a metafunction that changes the element to a mutant, and embeds the metafunction in the source code (Step S1). The replacing unit 131 outputs the replaced source code to the compiler 132. When the replaced source code is input from the replacing unit 131, the compiler 132 compiles the replaced source code into an intermediate code (Step S2). The compiler 132 outputs the compiled intermediate code to the state managing unit 133.

The state managing unit 133 receives an input of a test item and a mutation operator list from the input unit 111. Furthermore, the state managing unit 133 receives an input of the intermediate code from the compiler 132. The state managing unit 133, when the intermediate code is input, selects a test case on the basis of the test item and the mutation operator list (Step S3). The state managing unit 133, upon selecting the test case, generates an initial execution state (Step S4). The state managing unit 133, upon generating the initial execution state, performs the state selecting process (Step S5).

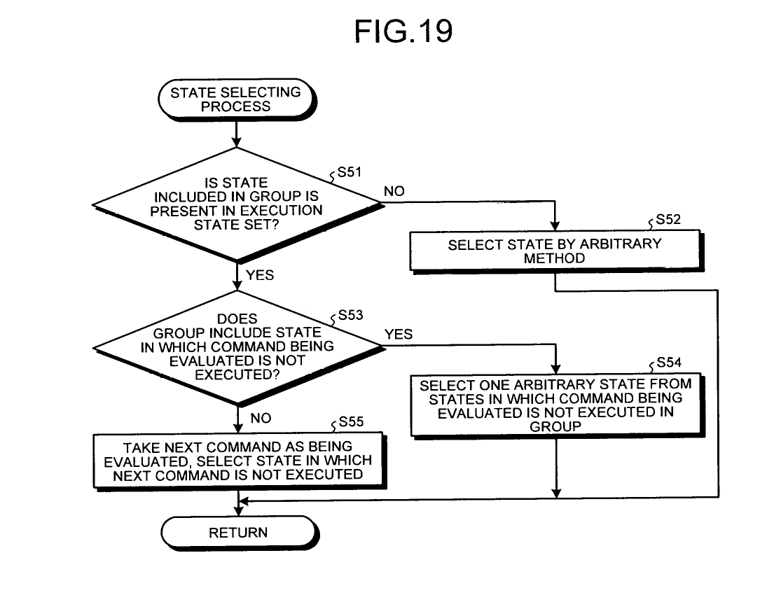

The state selecting process will be described below with reference to FIG. 19. FIG. 19 is a flowchart illustrating an example of the state selecting process.

As the state selecting process, the state managing unit 133 first refers to the execution state set storage unit 123, and determines whether a state that is included in the group is present in an execution state set (Step S51). If the state included in the group is not present (NO at Step S51), the state managing unit 133 selects a state by an arbitrary method (Step S52), and returns to the original process.

If the state included in the group is present (YES at Step S51), the state managing unit 133 determines whether the group includes states in which a command being evaluated is not executed (Step S53). If the group includes the states in which the command being evaluated is not executed (YES at Step S53), the state managing unit 133 selects one arbitrary state from the states in which the command being evaluated is not executed in the group (Step S54), and returns to the original process.

If the group does not include the states in which the command being evaluated is not executed (NO at Step S53) the state managing unit 133 takes a next command as being evaluated, selects a state in which the next command is not executed (Step S55), and returns to the original process. When the process return to the original process, the state managing unit 133 outputs a state ID of the selected state to the command evaluating unit 134. Therefore, the analyzing apparatus 100 can select a state.

Referring back to FIG. 18, the command evaluating unit 134, when the state ID is input from the state managing unit 133, refers to the command storage unit 121 and the execution state set storage unit 123 and reads a command (Step S6). The command evaluating unit 134, upon reading the command, determines whether a state indicated by the state ID is included in a group and the command is other than a command without an adverse effect (Step S7). If the state is included in the group and the command is other than the command without an adverse effect (YES at Step S7), the command evaluating unit 134 outputs a group dissolution instruction to the state managing unit 133.

The state managing unit 133, when the group dissolution instruction is input from the command evaluating unit 134, deletes the field of the synchronous execution group in the execution state set storage unit 123 and dissolves the group (Step S8). The state managing unit 133, when the group is dissolved, outputs dissolution completion information to the command evaluating unit 134.

If the state is included in the group and the command is not other than the command without an adverse effect (NO at Step S7) or if dissolution completion information is input from the state managing unit 133, determines whether the command is a call for the metafunction (Step S9). If the command is not a call for the metafunction (NO at Step S9), the command evaluating unit 134 executes the command (Step S11), and outputs command execution information to the state managing unit 133.

If the command is a call for the metafunction (YES at Step S9), the command evaluating unit 134 determines whether the metafunction is included in the mutation operator list (Step S10). If the metafunction is not included in the mutation operator list (NO at Step S10), the command evaluating unit 134 executes the command (Step S11), and outputs command execution information to the state managing unit 133. If the metafunction is included in the mutation operator list (YES at Step S10), the command evaluating unit 134 outputs a state split instruction to the state managing unit 133.

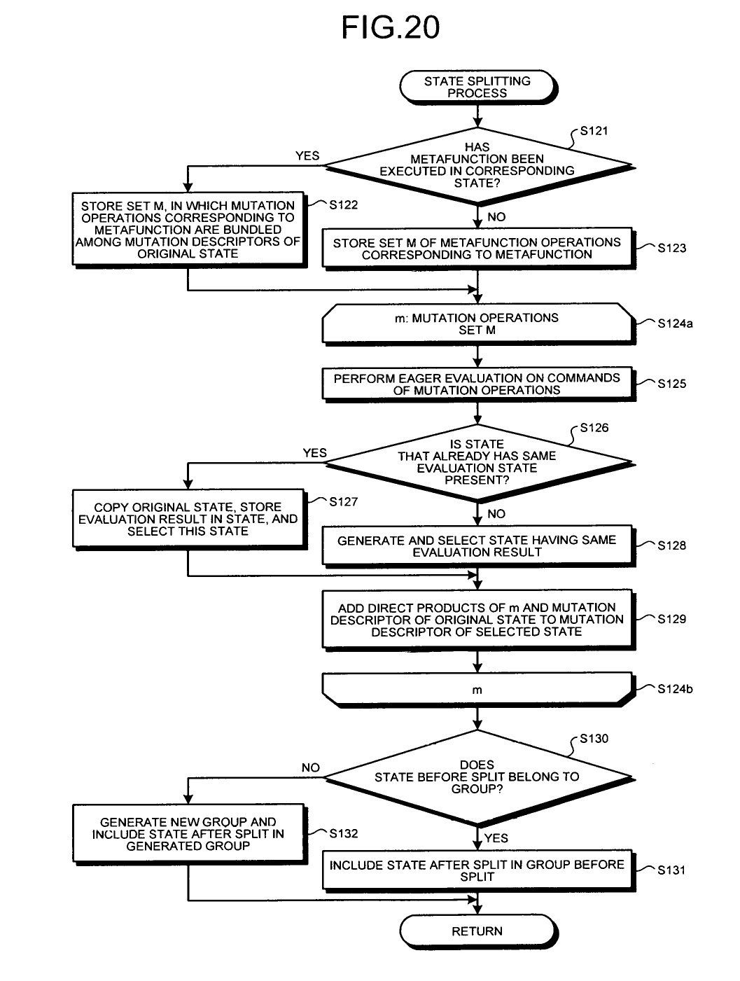

The state managing unit 133, when the state split instruction is input from the command evaluating unit 134, performs the state splitting process (Step S12). The state splitting process will be described below with reference to FIG. 20. FIG. 20 is a flowchart illustrating an example of the state splitting process. The state managing unit 133 determines whether the metafunction has been executed in a state corresponding to the state split instruction (Step S121). In the case of the executed metafunction (YES at Step S121), the state managing unit 133 stores a set M, in which mutation operations corresponding to the metafunction are bundled among mutation descriptors of an original state, in the execution state set storage unit 123 in association with the state ID (Step S122). The state managing unit 133, upon storing the set M in association with the state ID in the execution state set storage unit 123, outputs an evaluation instruction to the command evaluating unit 134.

In the case of not being the executed metafunction (NO at Step S121), the state managing unit 133 stores a set M of mutation operations corresponding to the metafunction in the execution state set storage unit 123 in association with the state ID (Step S123). The state managing unit 133, upon storing the set M in association with the state ID in the execution state set storage unit 123, outputs an evaluation instruction to the command evaluating unit 134.

The command evaluating unit 134, when the evaluation instruction is input from the state managing unit 133, repeats the process from Step S124a to Step S124b in order to perform an eager evaluation, determination of the need of state splitting, and a calculation of a direct product for each of the mutation operations m in the set M. The command evaluating unit 134 refers to the command storage unit 121 and the execution state set storage unit 123 and performs an eager evaluation on commands of the mutation operations m (Step S125). The command evaluating unit 134 stores command evaluation results of the mutation operations m in the evaluation result storage unit 122.

The command evaluating unit 134 determines whether a state that already has the same evaluation result is present (Step S126). If a state that already has the same evaluation result is present (YES at Step S126), the command evaluating unit 134 copies an original state, stores the evaluation result in the state, and selects the state (Step S127). If a state that already has the same evaluation result is not present (NO at Step S126), the command evaluating unit 134 generates a state that has the same evaluation result and selects the state (Step S128).

The command evaluating unit 134 calculates direct products of the mutation operations m and the mutation descriptor of the original state, and adds the direct products to a mutation descriptor of the selected state, thereby updating the execution state set storage unit 123 (Step S129). The command evaluating unit 134, upon completing the eager evaluation, the determination of the need of state splitting, and the calculation of the direct product with respect to each of the mutation operations m in the set M, outputs a group determination instruction to the state managing unit 133.

The state managing unit 133, when the group determination instruction is input from the command evaluating unit 134, refers to the execution state set storage unit 123 and determines whether a state before the split belongs to a group (Step S130). If the state before the split belongs to the group (YES at Step S130), the state managing unit 133 includes a state after the split in the group before the split (Step S131). If the state before the split does not belong to a group (NO at Step S130), the state managing unit 133 generates a new group and includes the state after the split in the generated group (Step S132). The state managing unit 133, upon classifying the split state into the group, returns to the original process. Therefore, the analyzing apparatus 100 can split the state.

Referring back to FIG. 18, the state managing unit 133, when the state splitting process ends or when the command execution information is input from the command evaluating unit 134, determines whether the state is included in a group and whether the same command has been executed in all of states in the group (Step S13). If the state is included in and the same command has been executed in all of the states in the group (YES at Step S13), the state managing unit 133 performs the state merging process (Step S14). If the state is included in the group and the same command has not been executed in all of the states in the group (NO at Step S13), the state managing unit 133 performs the state completion checking process (Step S15).

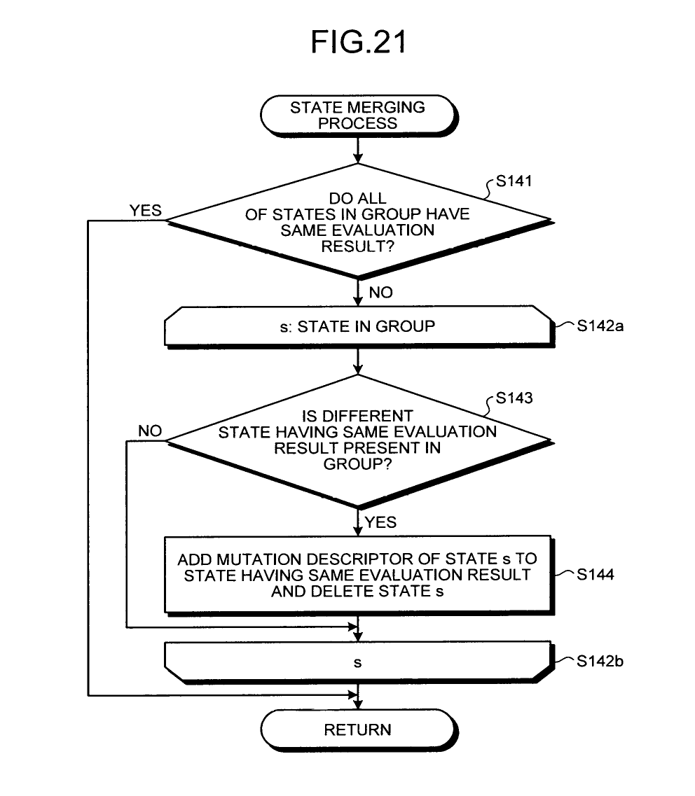

The state merging process will be described below with reference to FIG. 21. FIG. 21 is a flowchart illustrating an example of the state merging process. The state managing unit 133 determines whether all of the states in the group have the same evaluation result (Step S141). If all of the states in the group have the same evaluation result (YES at Step S141), the state managing unit 133 returns to the original process. If all of the states in the group do not have the same evaluation result (NO at Step S141), the state managing unit 133 repeats the process from Step S142a to Step S142b to perform merging of the state s in the group.

The state managing unit 133 determines whether a different state having the same evaluation result is present in the group (Step S143). If a different state having the same evaluation result is present in the group (YES at Step S143), the state managing unit 133 adds a mutation descriptor of the state s to the state having the same evaluation result, and deletes the state s (Step S144). If a different state having the same evaluation result is not present in the group (NO at Step S143), the state managing unit 133 performs merging of a next state. The state managing unit 133, upon completing the merging of the state s in the group, returns to the original process. Therefore, the analyzing apparatus 100 can merge the state.

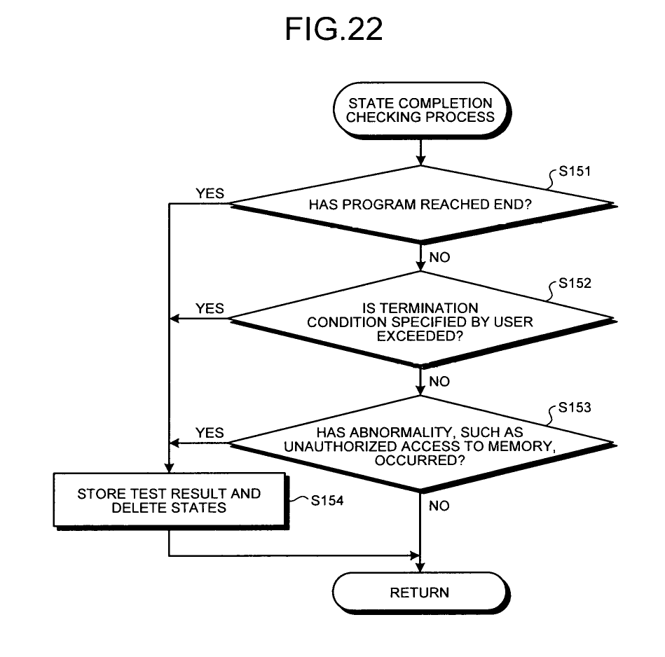

Referring back to FIG. 18, the state managing unit 133 performs the state completion checking process (Step S15). The state completion checking process will be described below with reference to FIG. 22. FIG. 22 is a flowchart illustrating an example of the state completion checking process. The state managing unit 133 determines whether a program has reached an end (Step S151). If the program has reached the end (YES at Step S151), the state managing unit 133 refers to the execution state set storage unit 123, stores a test result in the test result storage unit 124, deletes the states in the execution state set storage unit 123 (Step S154), and returns to the original process.

If the program has not reached the end (NO at Step S151), the state managing unit 133 determines whether a termination condition specified by the user is exceeded (Step S152). If the termination condition specified by the user is exceeded (YES at Step S152), the state managing unit 133 proceeds to Step S154. If the termination condition specified by the user is not exceeded (NO at Step S152), the state managing unit 133 determines whether an abnormality, such as an unauthorized access to a memory, has occurred (Step S153). If an abnormality has occurred (YES at Step S153), the state managing unit 133 proceeds to Step S154. If an abnormality has not occurred (NO at Step S153), the state managing unit 133 returns to the original process. Therefore, the analyzing apparatus 100 can check completion of the state.

Referring back to FIG. 18, the state managing unit 133 determines whether all of the states are completed (Step S16). If all of the states are not completed (NO at Step S16), the state managing unit 133 returns to Step S5. If all of the states are completed (YES at Step S16), the state managing unit 133 determines whether all of test cases have been executed (Step S17). If all of the test cases have not been executed (NO at Step S17), the state managing unit 133 returns to Step S3. If all of the test cases have been executed (YES at Step S17), the state managing unit 133 outputs an output instruction to the output unit 135.

The output unit 135, when the output instruction is input from the state managing unit 133, refers to the test result storage unit 124 and calculates a mutation score. Furthermore, the output unit 135 generates a result report based on the calculated mutation score and mutants with “Pass” in the item of the test pass-fail. The output unit 135 generates a result screen including the result report, and outputs and displays the generated result screen to the display unit 112 (Step S18). Therefore, the analyzing apparatus 100 can reduce the number of states of a higher order mutation. That is, the analyzing apparatus 100 can reduce calculation cost of the mutation analysis.

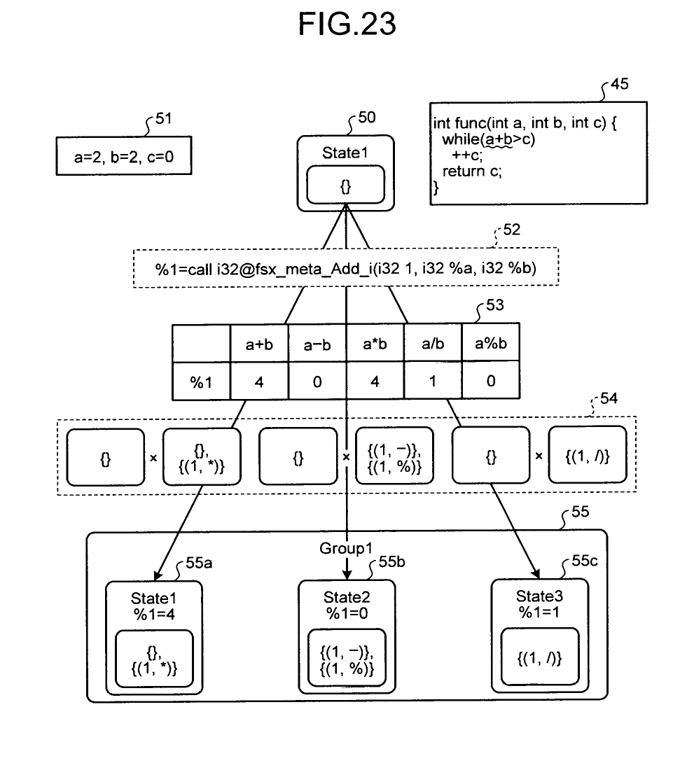

Next, a specific example of the analysis process will be described with reference to FIG. 23 to FIG. 47. In the following description, an explanation will be given by focusing on each state. Furthermore, the state ID is represented in the form of “State and number”, such as “State1” or “State2”, but the same state ID will be denoted by different signs before and after update. Moreover, in the specific example, the source code 45 illustrated in FIG. 13, the replaced source code 46 illustrated in FIG. 14, and the intermediate code 47 illustrated in FIG. 15 are used. In the specific example, it is assumed that information on the state is appropriately stored in the execution state set storage unit 123.

FIG. 23 to FIG. 30 are diagrams for explaining an example of a first while loop. In FIG. 23 to FIG. 30, the first while loop for the source code 45 is illustrated. A state 50 with the state ID “State1” corresponds to the second line of the source code 45. Furthermore, a test case corresponds to values indicated by a test case 51.

In FIG. 23, a command is first evaluated, and then a state is split. The state 50 is first evaluated with respect to a command 52. The command 52 corresponds to a wavy line portion “a +b” in the source code 45. A register value “%1” in the command 52 is a value corresponding to a mutant of an operator “+” as illustrated in a table 53. In this case, each of “a +b” and “a*b” has the register value “%1” of “4”, that is, the same result. Therefore, in FIG. 23, a state 55a with the state ID “State1” is generated with respect to “%1=4”. Similarly, each of “a−b” and “a % b” has the register value “%1” of “0”, that is, the same result. Therefore, in FIG. 23, a state 55b with the state ID “State2” is generated with respect to “%1=0”. “a/b” has the register value “%1” of “1”, and there is no other mutant having the same result. Therefore, in FIG. 23, a state 55c with the state ID “State3” is generated with respect to “%1=1”.

Subsequently, in FIG. 23, as indicated by a direct product calculation 54, direct products of a mutation descriptor “{}” of the state 50 by a mutation descriptor “{}” indicating “+” and a mutation descriptor “{1, *}” indicating “*” are calculated as mutation descriptors corresponding to the state 55a. The calculated mutation descriptors “{}, {1, *}” are stored, as the mutation descriptors corresponding to the state 55a, in the execution state set storage unit 123. Similarly, the mutation descriptors corresponding to the state 55b and the state 55c are calculated as indicated by the direct product calculation 54, and stored in the execution state set storage unit 123. In FIG. 23, the state 55a, the state 55b, and the state 55c are classified into a generated group 55. The group 55 will be referred to as “Group1” for convenience of explanation. The state 55a, the state 55b, and the state 55c belonging to the group 55 are evaluated in parallel, that is, at the same time.

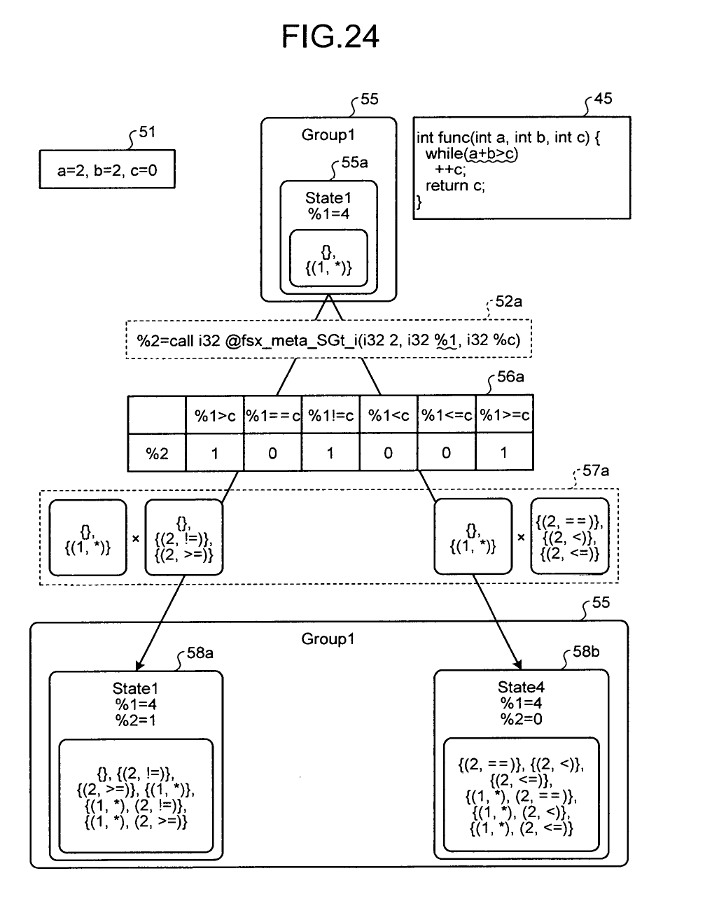

In FIG. 24, the state 55a is first evaluated with respect to a command 52a. The command 52a corresponds to a wavy line portion “a +b >c” in the source code 45. Furthermore, the register value “%1” is substituted into the command 52a as illustrated in a wavy line portion. A register value “%2” in the command 52a is a value corresponding to a mutant of an operator “>” as illustrated in a table 56a. In this case, each of “%1>c”, “%1!=c”, and “%1>=c” has the register value “%2” of “1”, that is, the same result. Therefore, in FIG. 24, the state ID “State1” is updated with respect to “%2=1” and a state 58a is obtained. Incidentally, information on “%1=4” is also held in the state 58a. Similarly, a state 58b with the state ID “State4” is generated with respect to “%2=0”.

Subsequently, in FIG. 24, similarly to FIG. 23, direct products are calculated as indicated by a direct product calculation 57a. The calculated direct products are stored, as mutation descriptors corresponding to the state 58a and the state 58b, in the execution state set storage unit 123. The state 58a and the state 58b have the command 52a that is a command without an adverse effect, so that they are classified into the group 55.

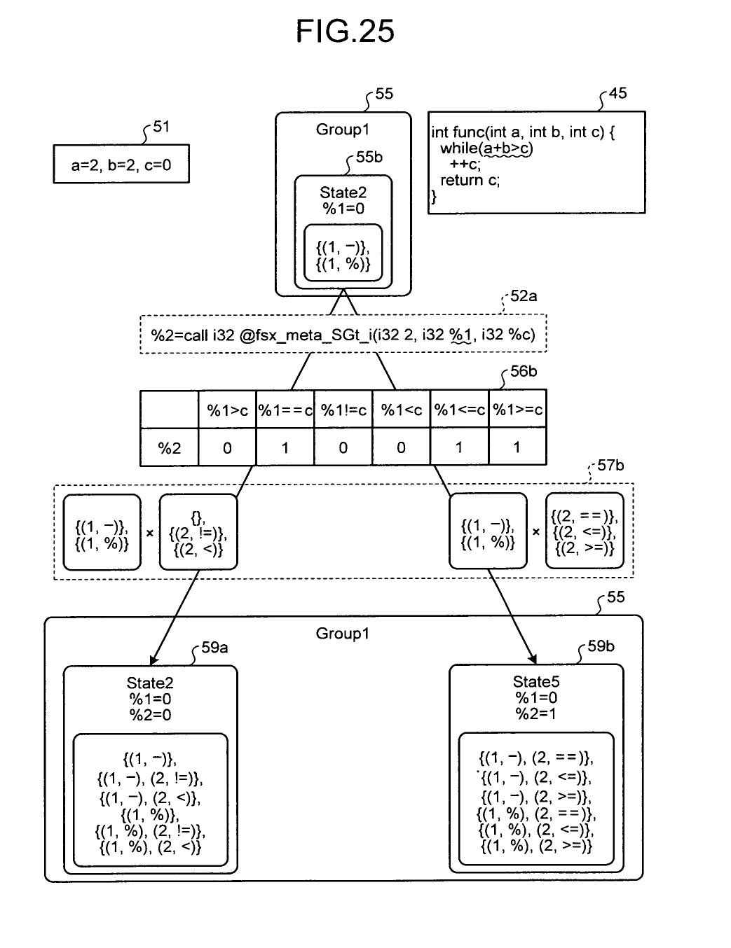

In FIG. 25, the state 55b is first evaluated with respect to the command 52a. The command 52a corresponds to the wavy line portion “a+b>c” in the source code 45. Furthermore, the register value “%1” is substituted into the command 52a as illustrated in the wavy line portion.

The register value “%2” in the command 52a is a value corresponding to a mutant of the operator “>” as illustrated in a table 56b. In this case, each of “%1>c”, “%1!=c”, and “%1<c” has the register value “%2” of “0”, that is, the same result. Therefore, in FIG. 25, the state ID “State2” is updated with respect to “%2=0” and a state 59a is obtained. Incidentally, information on “%1=0” is also held in the state 59a. Similarly, a state 59b with the state ID “State5” is generated with respect to “%2=1”.

Subsequently, in FIG. 25, similarly to FIG. 23, direct products are calculated as indicated by a direct product calculation 57b. The calculated direct products are stored, as mutation descriptors corresponding to the state 59a and the state 59b, in the execution state set storage unit 123. The state 59a and the state 59b have the command 52a that is a command without an adverse effect, so that they are classified into the group 55.

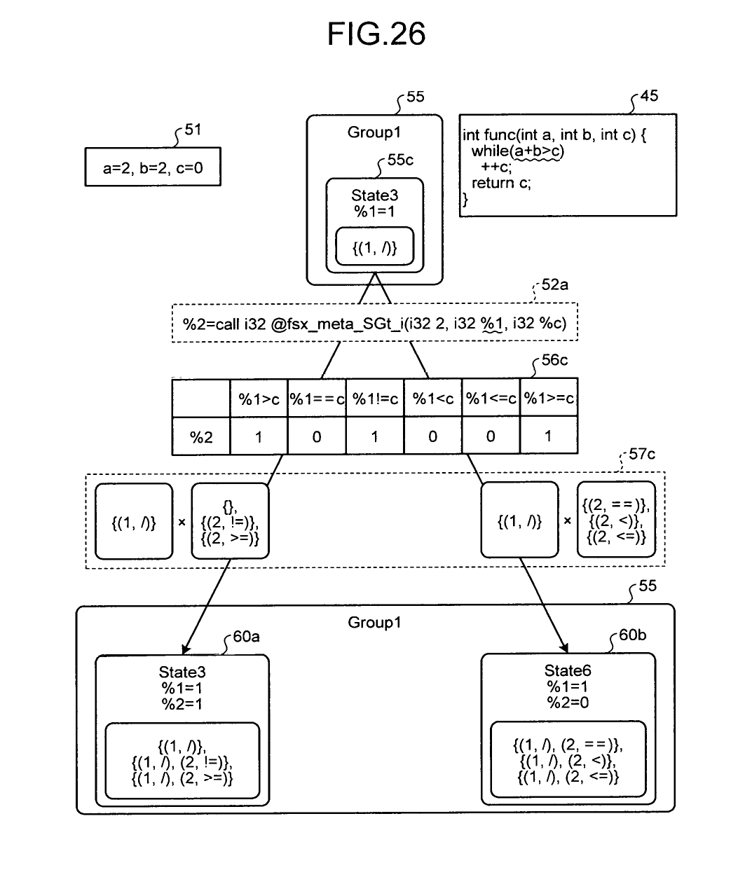

In FIG. 26, the state 55c is first evaluated with respect to the command 52a. The command 52a corresponds to the wavy line portion “a+b>c” in the source code 45. Furthermore, the register value “%1” is substituted into the command 52a as illustrated in the wavy line portion. The register value “%2” in the command 52a is a value corresponding to a mutant of the operator “>” as illustrated in a table 56c. In this case, each of “%1>c”, “%1!=c”, and “%1>=c” has the register value “%2” of “1”, that is, the same result. Therefore, in FIG. 26, a state 60a with the state ID “State3” is generated with respect to “%2=1”. Incidentally, information on “%1=1” is also held in the state 60a. Similarly, a state 60b with a state ID “State6” is generated with respect to “%2=0”.

Subsequently, in FIG. 26, similarly to FIG. 23, direct products are calculated as indicated by a direct product calculation 57c. The calculated direct products are stored, as mutation descriptors corresponding to the state 60a and the state 60b, in the execution state set storage unit 123. The state 60a and the state 60b have the command 52a that is a command without an adverse effect, so that they are classified into the group 55.

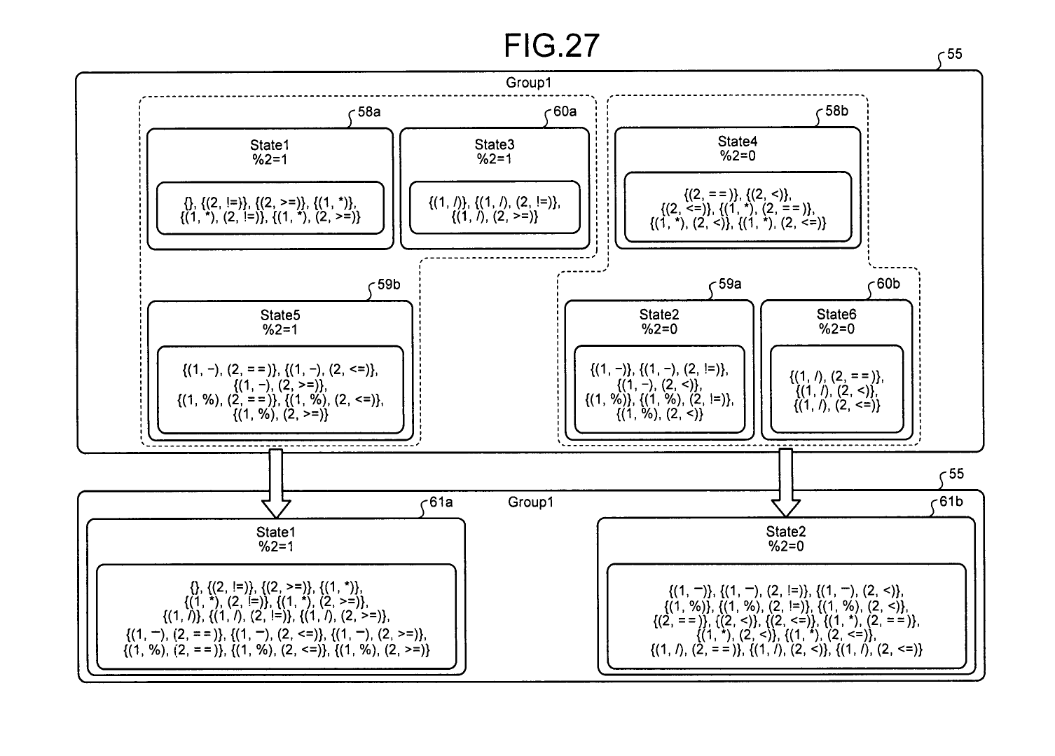

In FIG. 27, in the group 55, the states having the same calculation result of the register value “%2” are merged. In FIG. 27, the state 58a, the state 59b, and the state 60a are merged, the state ID “State1” is updated, and a state 61a is obtained. Similarly, in FIG. 27, the state 58b, the state 59a, and the state 60b are merged, the state ID “State2” is updated, and a state 61b is obtained.

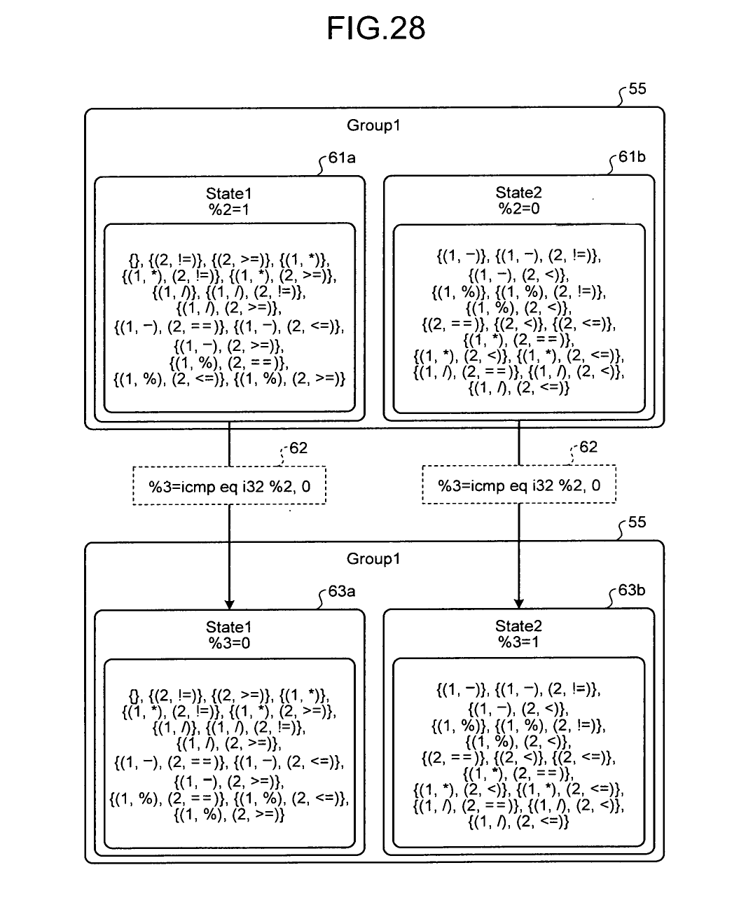

As illustrated in FIG. 28, the states having different calculation results are not merged. In FIG. 28, each of the state 61a and the state 61b belonging to the group 55 is evaluated with respect to a command 62. The command 62 is a command to compare “%2” and “0”. The state 61a has “%2=1”, so that “%3” that is a result of the command 62 becomes “0” indicating false. Therefore, the state ID “State1” is updated and a state 63a is obtained. In contrast, the state 61b has “%2=0”, so that “%3” that is a result of the command 62 becomes “1” indicating true. Therefore, the state ID “State2” is updated and a state 63b is obtained. Consequently, the state 63a and the state 63b have different calculation results and therefore not merged.

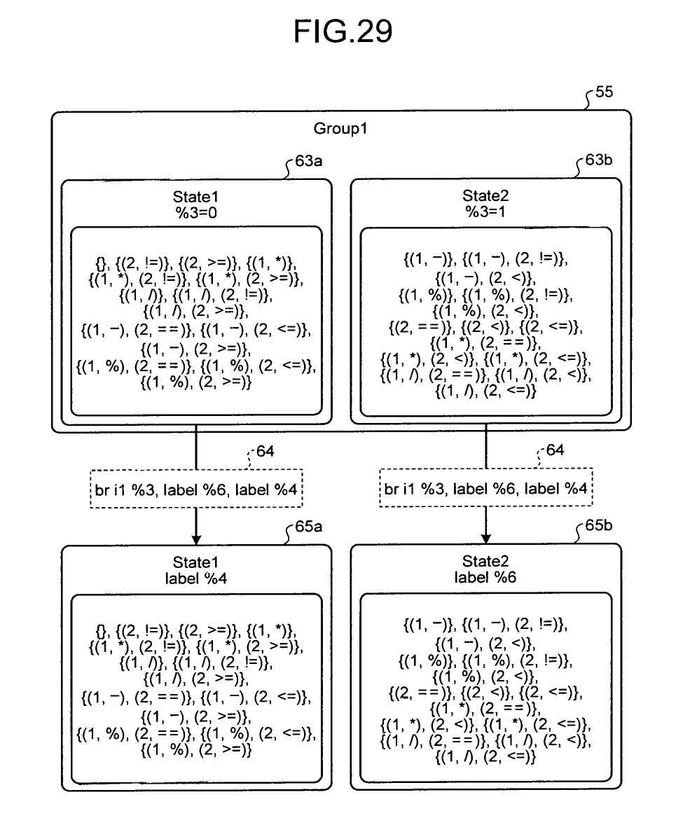

As illustrated in FIG. 29, if a command other than the command without an adverse effect appears, the group 55 is dissolved. In FIG. 29, each of the state 63a and the state 63b belonging to the group 55 is evaluated with respect to a command 64. The command 64 is a branch instruction and may cause an adverse effect. Therefore, the group 55 is dissolved. The state 63a is branched into “%4”, the state ID “State1” is updated, and a state 65a is obtained. In contrast, the state 63b is branched into “%6”, the state ID “State2” is updated, and a state 65b is obtained. The state 65a is preferentially executed because the group 55 is dissolved. Furthermore, the state 65b exits the while statement, returns “0”, and is terminated.

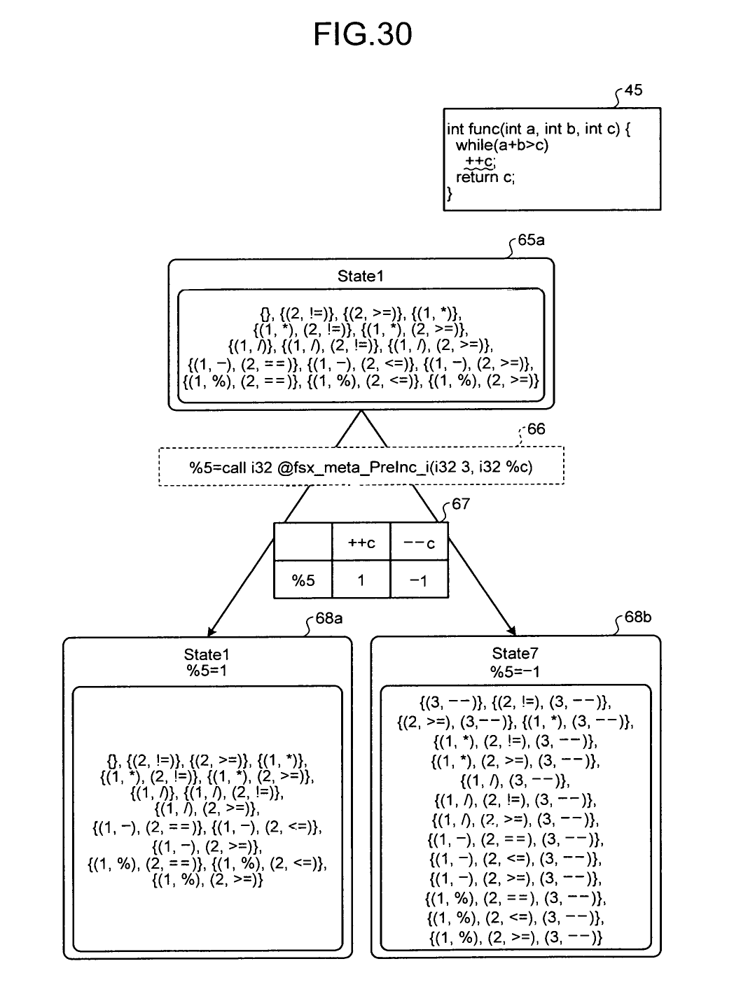

As illustrated in FIG. 30, the state 65a reaches the third line of the source code 45. In FIG. 30, the state 65a is evaluated with respect to a command 66. The command 66 corresponds to a wavy line portion “++c” in the source code 45. A register value “%5” in the command 66 is a value corresponding to a mutant of an operator “++” as illustrated in a table 67. Incidentally, if a result of the command is not used in the subsequent stage, mutations into “c++” and “c−−” are integrated with “++c” and “−−c”. In FIG. 30, the state ID “State1” is updated with respect to “%5 =1” and a state 68a is obtained. Similarly, a state 68b with a state ID “State7” is generated with respect to “%5 =−1”.

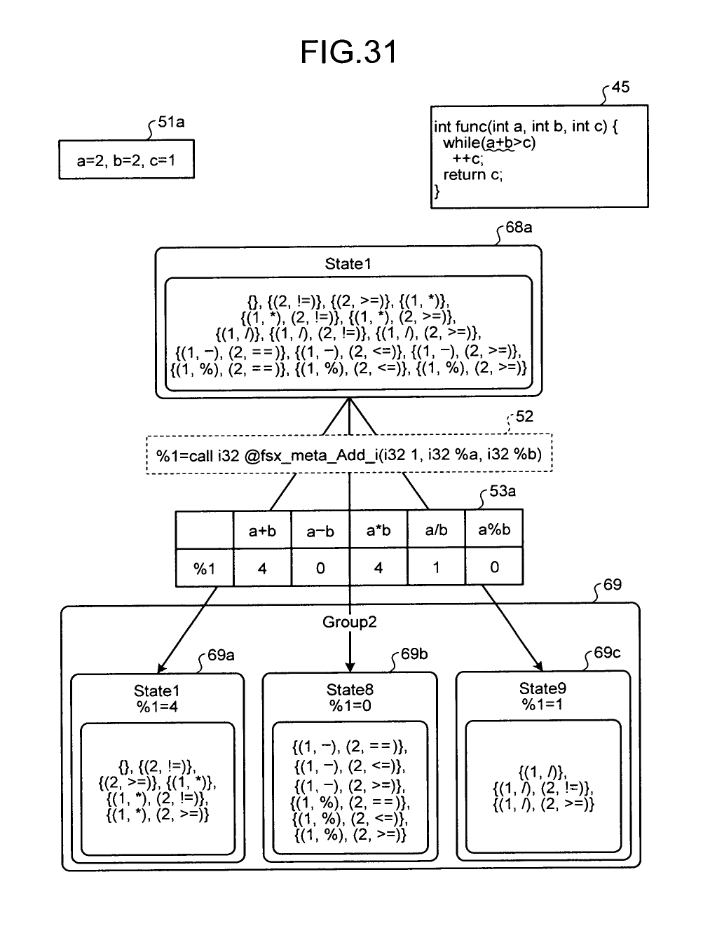

FIG. 31 to FIG. 37 are diagrams for explaining an example of a second while loop. In FIG. 31 to FIG. 37, the second while loop for the source code 45 is illustrated. Furthermore, a test case corresponds to values indicated by a test case 51a.

The state 68a in FIG. 31 corresponds to the state ID “State1” in the first while loop. The state 68a is first evaluated with respect to the command 52. The register value “%1” in the command 52 is a value corresponding to a mutant of the operator “+” as illustrated in a table 53a. In this case, each of “a+b” and “a*b” has the register value “%1” of “4”, that is, the same result. Therefore, in FIG. 31, the state ID “State1” is updated with respect to “%1=4” and a state 69a is obtained. In this case, in the command 52, a mutation descriptor “{}” and mutation descriptors with the mutation ID of “1” among mutation descriptors in the state 68a are evaluated. That is, the mutation descriptor “{}” is evaluated for mutation descriptors with the mutation IDs other than “1”. Similarly, each of “a−b” and “a%b” has the register value “%1” of “0”, that is, the same result. Therefore, in FIG. 31, a state 69b with a state ID “State8” is generated with respect to “%1=0”. “a/b” has the register value “%1” of “1”, and there is no other mutant having the same result. Therefore, in FIG. 31, a state 69c with a state ID “State9” is generated with respect to “%1=1”. Furthermore, in FIG. 31, the state 69a, the state 69b, and the state 69c are classified into a generated group 69. The group 69 will be referred to as “Group2” for convenience of explanation. The state 69a, the state 69b, and the state 69c belonging to the group 69 are evaluated in parallel, that is, at the same time.

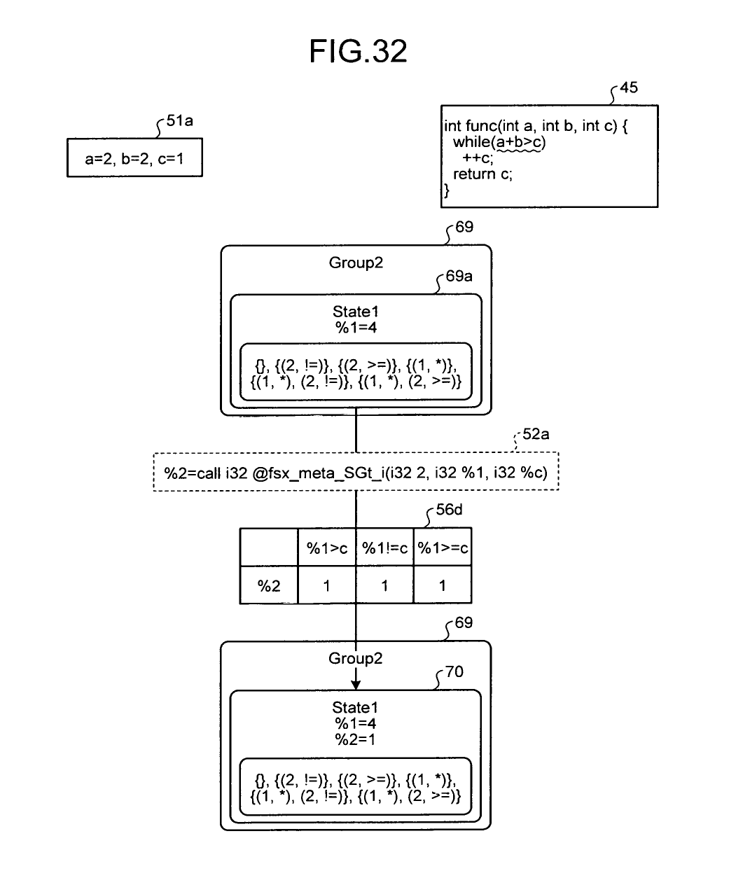

In FIG. 32, the state 69a is evaluated with respect to the command 52a. The register value “%2” in the command 52a is a value corresponding to a mutant of the operator “>” as illustrated in a table 56d. In this case, in the command 52a, a mutation descriptor “{}” and mutation descriptors with the mutation ID of “2” among mutation descriptors in the state 69a are evaluated. Here, each of “%1>c”, “%1!=c”, and “%1>=c” has the register value “%2” of “1”, that is, the same result. Therefore, in FIG. 32, the state ID “State” is updated with respect to “%2=1” and a state 70 is obtained. Incidentally, information on “%1=4” is also held in the state 70.

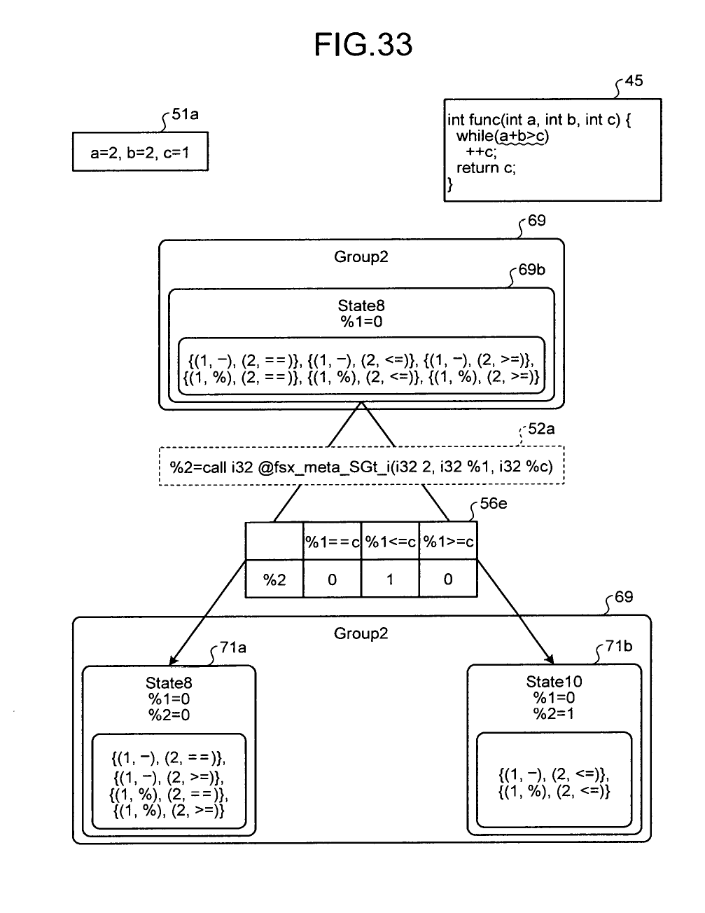

In FIG. 33, the state 69b is evaluated with respect to the command 52a. The register value “%2” in the command 52a is a value corresponding to a mutant of the operator “>” as illustrated in a table 56e. In this case, in the command 52a, mutation descriptors with the mutation ID of “2” among mutation descriptors in the state 69b are evaluated. Here, each of “%1==c” and “%1>=c” has the register value “%2” of “0”, that is, the same result. Therefore, in FIG. 33, the state ID “State8” is updated with respect to “%2=0” and a state 71a is obtained. Incidentally, information on “%1=0” is also held in the state 71a. Similarly, a state 71b with a state ID “State10” is generated with respect to “%2=1”. The state 71a and the state 71b have the command 52a that is a command without an adverse effect, so that they are classified into the group 69.

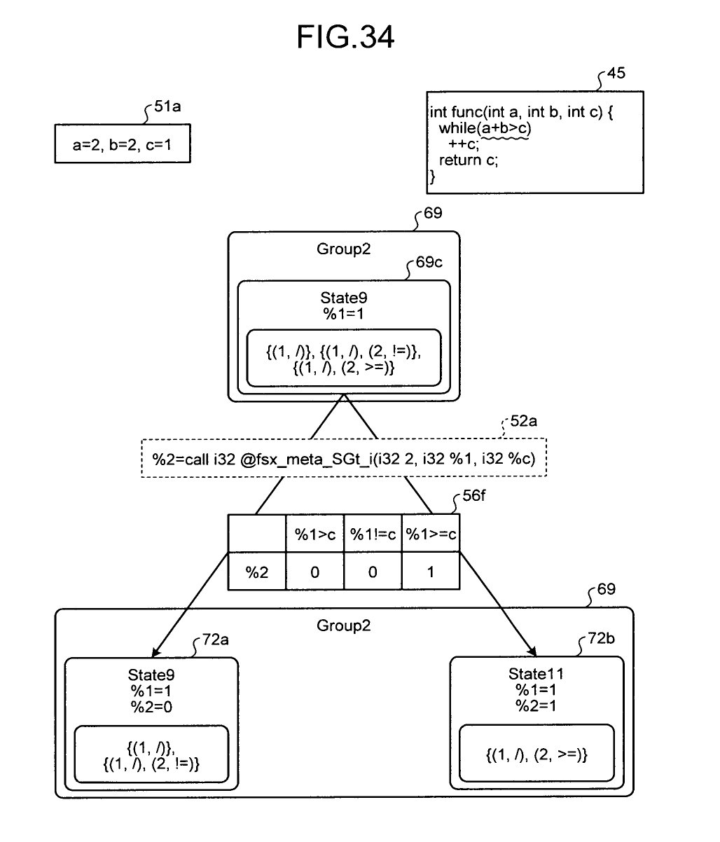

In FIG. 34, the state 69c is evaluated with respect to the command 52a. The register value “%2” in the command 52a is a value corresponding to a mutant of the operator “>” as illustrated in a table 56f. In this case, in the command 52a, mutation descriptors with the mutation ID of “2” among mutation descriptors in the state 69c are evaluated. Here, each of “%1>c” and “%1!=c” has the register value “%2” of “0”, that is, the same result. Therefore, in FIG. 34, the state ID “State9” is updated with respect to “%2=0” and a state 72a is obtained. Incidentally, information on “%1=1” is also held in the state 72a. Similarly, a state 72b with a state ID “State11” is generated with respect to “%2=1”. The state 72a and the state 72b have the command 52a that is a command without an adverse effect, so that they are classified into the group 69.

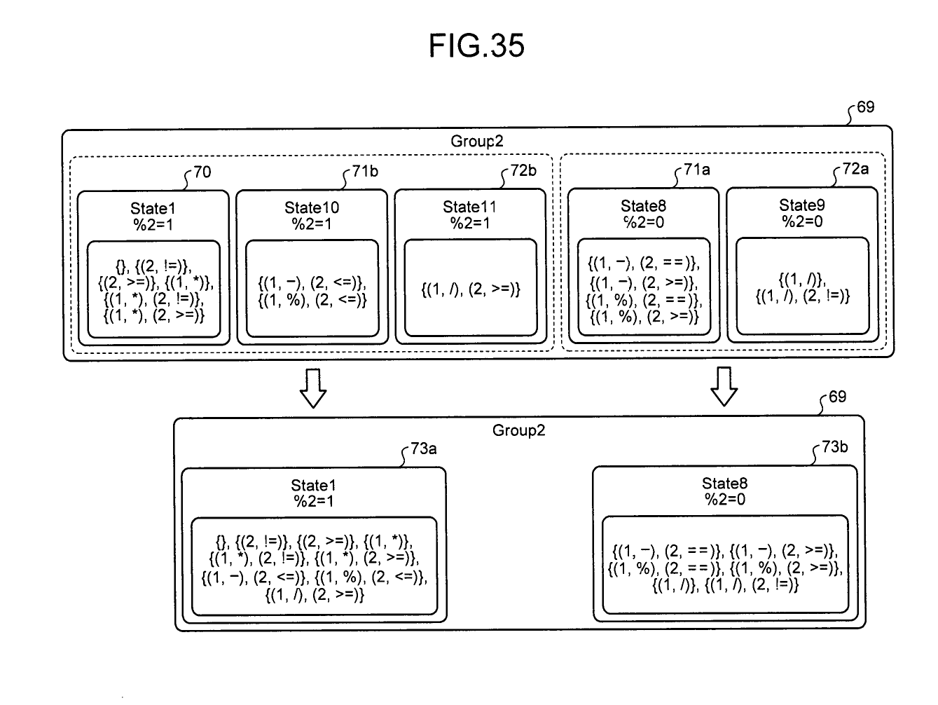

In FIG. 35, in the group 69, the states having the same calculation result of the register value “%2” are merged. In FIG. 35, the state 70, the state 71b, and the state 72b are merged, the state ID “State1”, is updated, and a state 73a is obtained. Similarly, in FIG. 35, the state 71a and the state 72a are merged, the state ID “State8” is updated, and a state 73b is obtained.

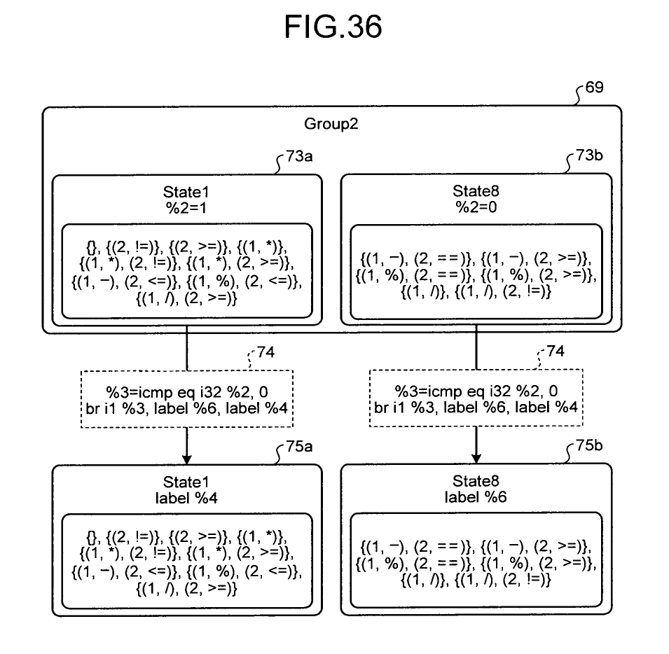

As illustrated in FIG. 36, the states having different calculation results are not merged. Furthermore, if a command other than the command without an adverse effect appears, the group 69 is dissolved. In FIG. 36, each of the state 73a and the state 73b belonging to the group 69 is evaluated with respect to a command 74. In the command 74, the command 62 illustrated in FIG. 28 and the command 64 illustrated in FIG. 29 are collectively described. The state 73a and the state 73b are not merged. Furthermore, the group 69 is dissolved. The state 73a is branched into “%4”, the state ID “State1” is updated, and a state 75a is obtained. In contrast, the state 73b is branched into “%6”, the state ID “State8” is updated, and a state 75b is obtained. The state 75a is preferentially executed because the group 69 is dissolved. Furthermore, the state 75b exits the while statement, returns “1”, and is terminated.

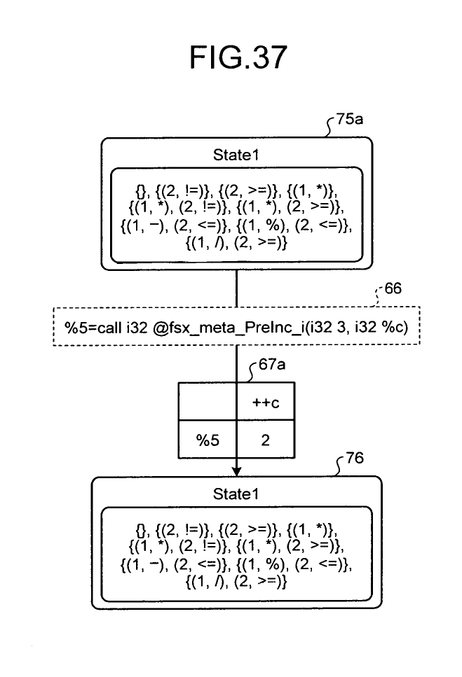

In FIG. 37, the state 75a is evaluated with respect to the command 66. A register value “%5” in the command 66 is a value corresponding to a mutant of the operator “++” as illustrated in a table 67a. In this case, in the command 66, a mutation descriptor “{}” and a mutation descriptor with the mutation ID of “3” among mutation descriptors in the state 75a are evaluated. However, the state 75a does not include a mutation descriptor with the mutation ID of “3”; therefore, the mutation descriptor “{}” is evaluated. In FIG. 37, the state ID “State1” is updated with respect to “%5=2” and a state 76 is obtained.

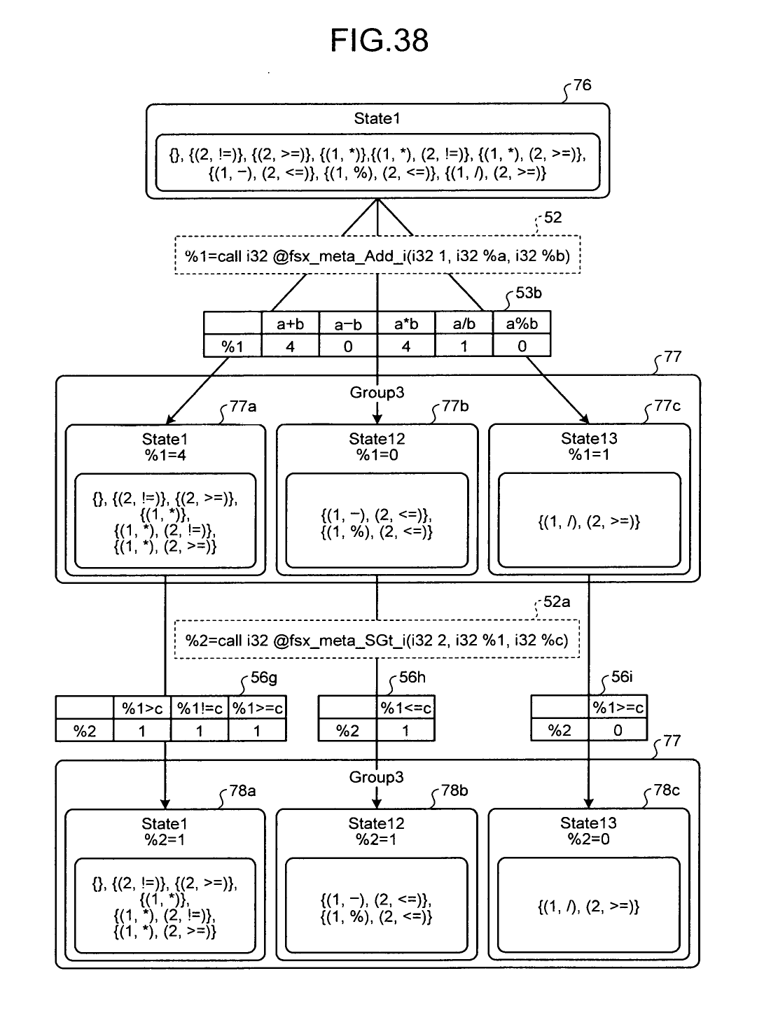

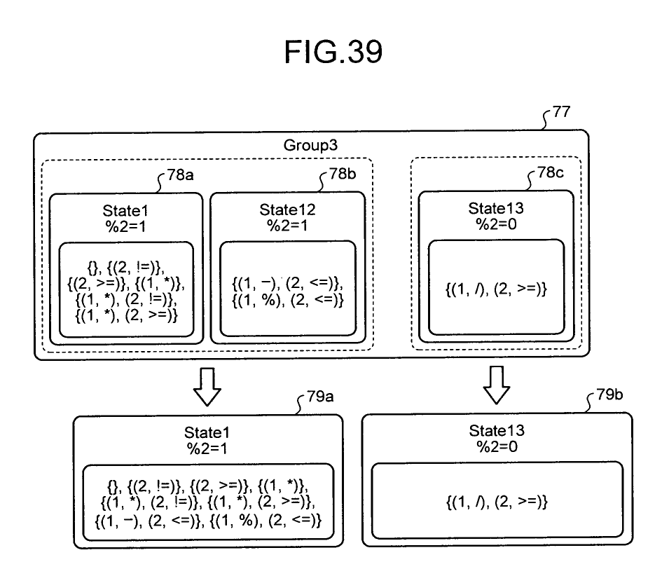

FIG. 38 and FIG. 39 are diagrams for explaining an example of a third while loop. In FIG. 38 and FIG. 39, the third while loop for the source code 45 is illustrated.

The state 76 in FIG. 38 corresponds to the state ID “State1” in the second while loop. The state 76 is first evaluated with respect to the command 52. The register value “%1” in the command 52 is a value corresponding to a mutant of the operator “+” as illustrated in a table 53b. In this case, each of “a+b” and “a*b” has the register value “%1” of “4”, that is, the same result. Therefore, in FIG. 38, the state ID “State1” is updated with respect to “%1=4” and a state 77a is obtained. In this case, in the command 52, a mutation descriptor “{}” and mutation descriptors with the mutation ID of “1” among mutation descriptors in the state 76 are evaluated. Similarly, each of “a−b” and “a % b” has the register value “%1” of “0”, that is, the same result. Therefore, in FIG. 38, a state 77b with a state ID “State12” is generated with respect to “%1=0”. “a/b” has the register value “%1” of “1”, and there is no other mutant having the same result. Therefore, in FIG. 38, a state 77c with a state ID “State13” is generated with respect to “%1=1”. Furthermore, in FIG. 38, the state 77a, the state 77b, and the state 77c are classified into a generated group 77. The group 77 will be referred to as “Group3” for convenience of explanation. The state 77a, the state 77b, and the state 77c belonging to the group 77 are evaluated in parallel, that is, at the same time.

Subsequently, the state 77a is evaluated with respect to the command 52a. The register value “%2” in the command 52a is a value corresponding to a mutant of the operator “>” as illustrated in a table 56g. In this case, in the command 52a, a mutation descriptor “{}” and mutation descriptors with the mutation ID of “2” among mutation descriptors in the state 77a are evaluated. Here, each of “%1>c”, “%1!=c”, and “%1>=c” has the register value “%2” of “1”, that is, the same result. Therefore, in FIG. 38, the state ID “State1” is updated with respect to “%2=1” and a state 78a is obtained.

The state 77b is evaluated with respect to the command 52a. The register value “%2” in the command 52a is a value corresponding to a mutant of the operator “>” as illustrated in a table 56h. In this case, in the command 52a, a mutation descriptor “{}” and mutation descriptors with the mutation ID of “2” among mutation descriptors in the state 77b are evaluated. Here, “%1<=c” has the register value “%2” of “1, and there is no other mutant having the same result. Therefore, in FIG. 38, the state ID “State12” is updated with respect to “%2=1” and a state 78b is obtained.

The state 77c is evaluated with respect to the command 52a. The register value “%2” in the command 52a is a value corresponding to a mutant of the operator “>” as illustrated in a table 56i. In this case, in the command 52, a mutation descriptor “0” and a mutation descriptor with the mutation ID of “2” among mutation descriptors in the state 77c are evaluated. Here, “%1>=c” has the register value “%2” of “0”, and there is no other mutant having the same result. Therefore, in FIG. 38, the state ID “State13” is updated with respect to “%2=0” and a state 78c is obtained. The state 78a, the state 78b, and the state 78c have the command 52a that is a command without an adverse effect, so that they are classified into the group 77.

In FIG. 39, in the group 77, the states having the same calculation result of the register value “%2” are merged. In FIG. 39, the state 78a and the state 78b are merged, the state ID “State1” is updated, and a state 79a is obtained. There is no state to be merged with the state 78c, so that the state ID “State13” is updated as it is and a state 79b is obtained. Furthermore, the group 77 is dissolved. Moreover, the state 79b exits the while statement, returns “2”, and is terminated. Thereafter, the same process as the second while loop is performed on the state 79a until the third while loop ends.

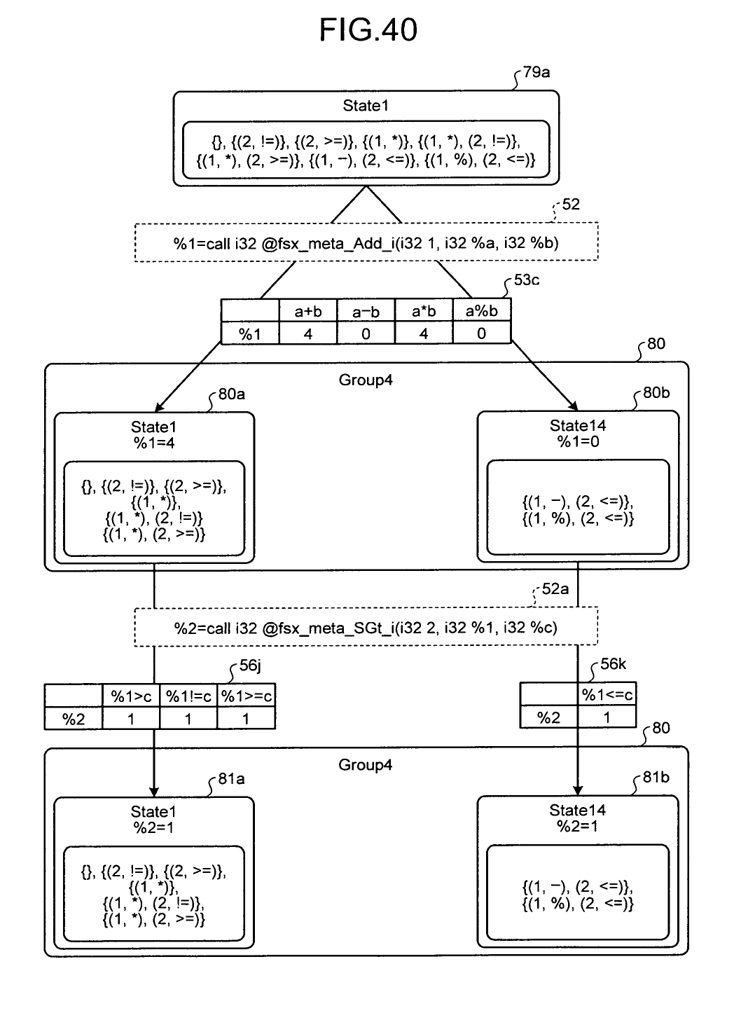

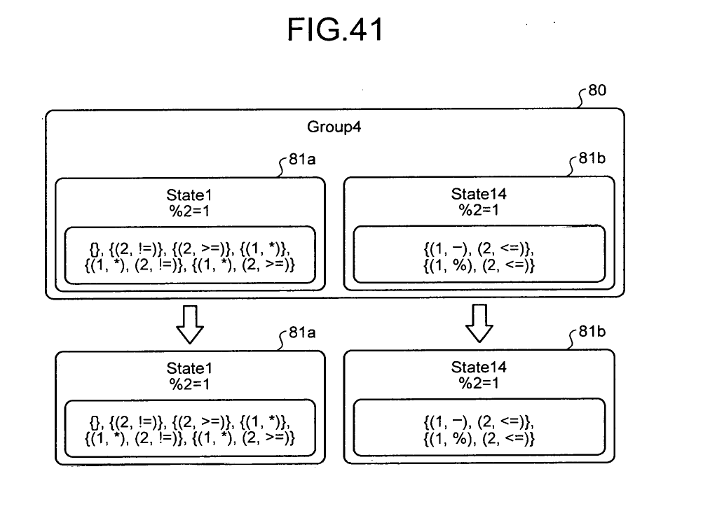

FIG. 40 and FIG. 41 are diagrams for explaining an example of a fourth while loop. In FIG. 40 and FIG. 41, the fourth while loop for the source code 45 is illustrated.

The state 79a in FIG. 40 corresponds to the state ID “State1” in the third while loop. The state 79a is first evaluated with respect to the command 52. The register value “%1” in the command 52 is a value corresponding to a mutant of the operator “+” as illustrated in a table 53c. In this case, each of “a+b” and “a*b” has the register value “%1” of “4”, that is, the same result. Therefore, in FIG. 40, the state ID “State1” is updated with respect to “%1=4” and a state 80a is obtained. In this case, in the command 52, a mutation descriptor “{}” and mutation descriptors with the mutation ID of “1” among mutation descriptors in the state 79a are evaluated. Similarly, each of “a−b” and “a % b” has the register value “%1” of “0”, that is, the same result. Therefore, in FIG. 40, a state 80b with a state ID “State14” is generated with respect to “%1=0”. Furthermore, in FIG. 40, the state 80a and the state 80b are classified into a generated group 80. The group 80 will be referred to as “Group4” for convenience of explanation. The state 80a and the state 80b belonging to the group 80 are evaluated in parallel, that is, at the same time.

Subsequently, the state 80a is evaluated with respect to the command 52a. The register value “%2” in the command 52a is a value corresponding to a mutant of the operator “>” as illustrated in a table 56j. In this case, in the command 52a, a mutation descriptor “{}” and mutation descriptors with the mutation ID of “2” among mutation descriptors in the state 80a are evaluated. Here, each of “%1>c”, “%1!=c”, and “%1>=c” has the register value “%2” of “1”, that is, the same result. Therefore, in FIG. 40, the state ID “State1” is updated with respect to “%2=1” and a state 81a is obtained.

The state 80b is evaluated with respect to the command 52a. The register value “%2” in the command 52a is a value corresponding to a mutant of the operator “>” as illustrated in a table 56k. In this case, in the command 52a, a mutation descriptor “{}” and mutation descriptors with the mutation ID of “2” among mutation descriptors in the state 80b are evaluated. Here, “%1<=c” has the register value “%2” of “1, and there is no other mutant having the same result. Therefore, in FIG. 40, the state ID “State14” is updated with respect to “%2=1” and a state 81b is obtained. The state 81a and the state 81b have the command 52a that is a command without an adverse effect, so that they are classified into the group 80.

In FIG. 41, in the group 80, if the states having the same calculation result of the register value “%2” are merged, the state 81a and the state 81b are returned to a single state. In such a case, state splitting and merging may be repeated; therefore, merging is not performed. Furthermore, the group 80 is dissolved. Moreover, the state 81b finally becomes an infinite loop and is therefore timed out. Thereafter, the same process as the third while loop is performed on the state 81a until the fourth while loop ends.

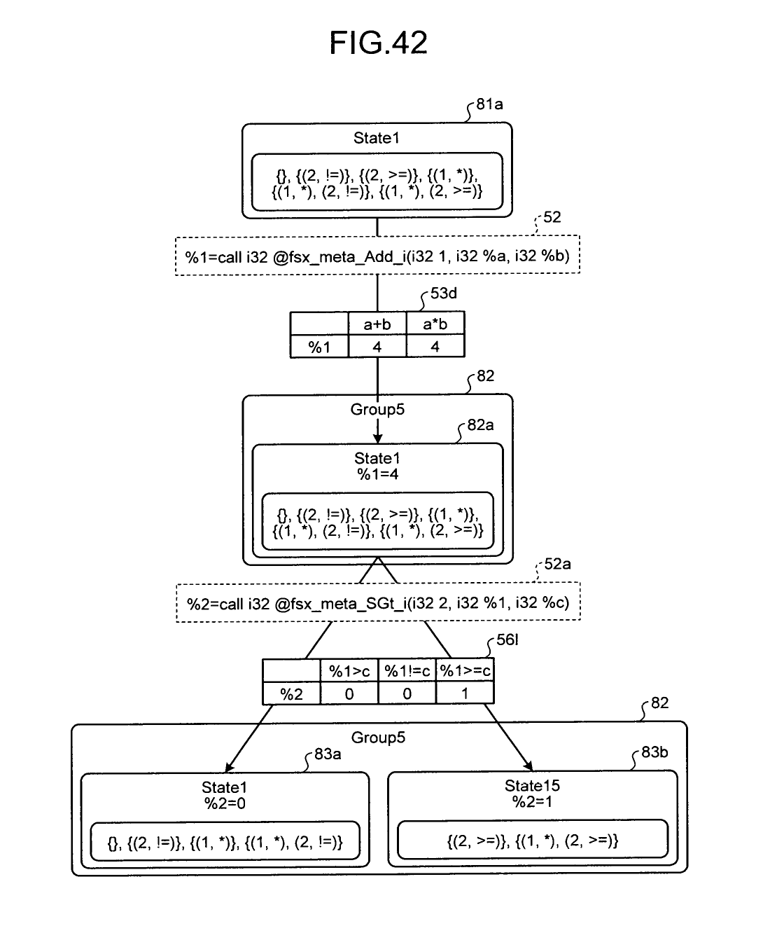

FIG. 42 is a diagram for explaining an example of a fifth while loop. In FIG. 42, the fifth while loop for the source code 45 is illustrated.

The state 81a in FIG. 42 corresponds to the state ID “State1” in the fourth while loop. The state 81a is first evaluated with respect to the command 52. The register value “%1” in the command 52 is a value corresponding to a mutant of the operator “+” as illustrated in a table 53d. In this case, each of “a+b” and “a*b” has the register value “%1” of “4”, that is, the same result. Therefore, in FIG. 42, the state ID “State1” is updated with respect to “%1=4” and a state 82a is obtained. In this case, in the command 52, a mutation descriptor “{}” and mutation descriptors with the mutation ID of “1” among mutation descriptors in the state 81a are evaluated. The state 82a is classified into a generated group 82. The group 82 will be referred to as “Group5” for convenience of explanation.

Subsequently, the state 82a is evaluated with respect to the command 52a. The register value “%2” in the command 52a is a value corresponding to a mutant of the operator “>” as illustrated in a table 561. In this case, in the command 52a, a mutation descriptor “{}” and mutation descriptors with the mutation ID of “2” among mutation descriptors in the state 82a are evaluated. Here, “%1>c” and “%1!=c” has the register value “%2” of “0”, that is, the same result. Therefore, in FIG. 42, the state ID “State1” is updated with respect to “%2=0” and a state 83a is obtained. Similarly, “%1>=c” has the register value “%2” of “1, and there is no other mutant having the same result. Therefore, in FIG. 42, a state 83b with a state ID “State15” is generated with respect to “%2=1”. Furthermore, in FIG. 42, the state 83a and the state 83b have the command 52a that is a command without an adverse effect, so that they are classified into the group 82. The state 83a and the state 83b belonging to the group 82 are evaluated in parallel, that is, at the same time.

In the group 82, there are no states having the same calculation result of the register value “%2”, so that merging is not performed. Furthermore, the group 82 is dissolved. Moreover, the state 83a exits the while statement, returns “4”, and is terminated. Furthermore, the state 83b is subjected to the while loop again, returns “5”, and is terminated.

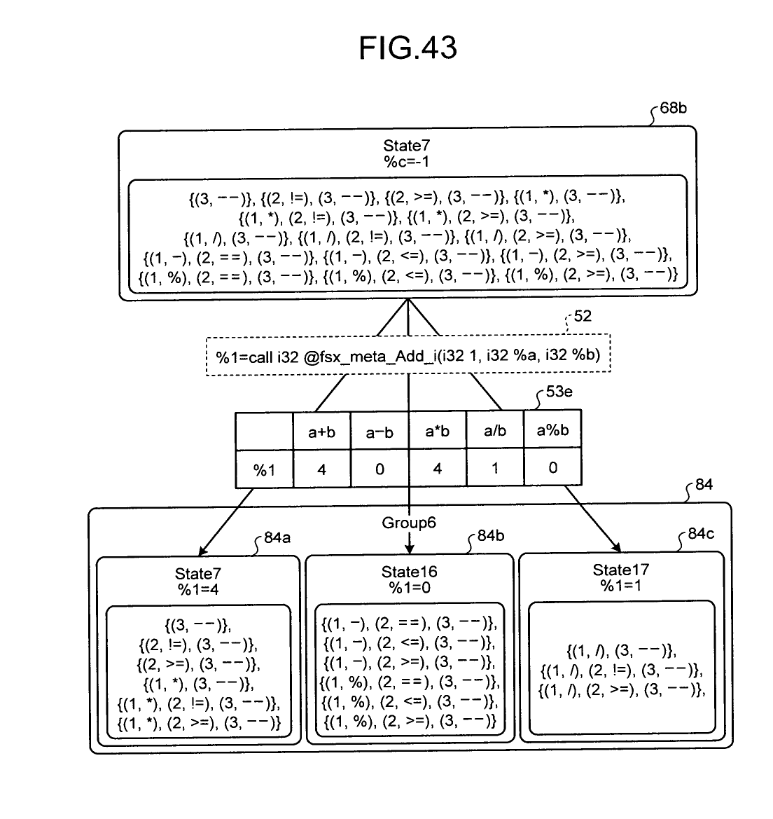

FIG. 43 to FIG. 46 are diagrams for explaining an example of the second while loop. In FIG. 43 to FIG. 46, the state 68b side indicated by the state ID “State7” in the second while loop for the source code 45 is illustrated.

The state 68b in FIG. 43 corresponds to the state ID “State7” in the first while loop. The state 68b is first evaluated with respect to the command 52. The register value “%1” in the command 52 is a value corresponding to a mutant of the operator “+” as illustrated in a table 53e. In this case, each of “a+b” and “a*b” has the register value “%1” of “4”, that is, the same result. Therefore, in FIG. 43, the state ID “State7” is updated with respect to “%1=4” and a state 84a is obtained. In this case, in the command 52, a mutation descriptor “{}” and mutation descriptors with the mutation ID of “1” among mutation descriptors in the state 68b are evaluated. Similarly, each of “a−b” and “a % b” has the register value “%1” of “0”, that is, the same result. Therefore, in FIG. 43, a state 84b with a state ID “State16” is generated with respect to “%1=0”. “a/b” has the register value “%1” of “1”, and there is no other mutant having the same result. Therefore, in FIG. 43, a state 84c with a state ID “State17” is generated with respect to “%1=1”. Furthermore, in FIG. 43, the state 84a, the state 84b, and the state 84c are classified into a generated group 84. The group 84 will be referred to as “Group6” for convenience of explanation. The state 84a, the state 84b, and the state 84c belonging to the group 84 are evaluated in parallel, that is, at the same time.

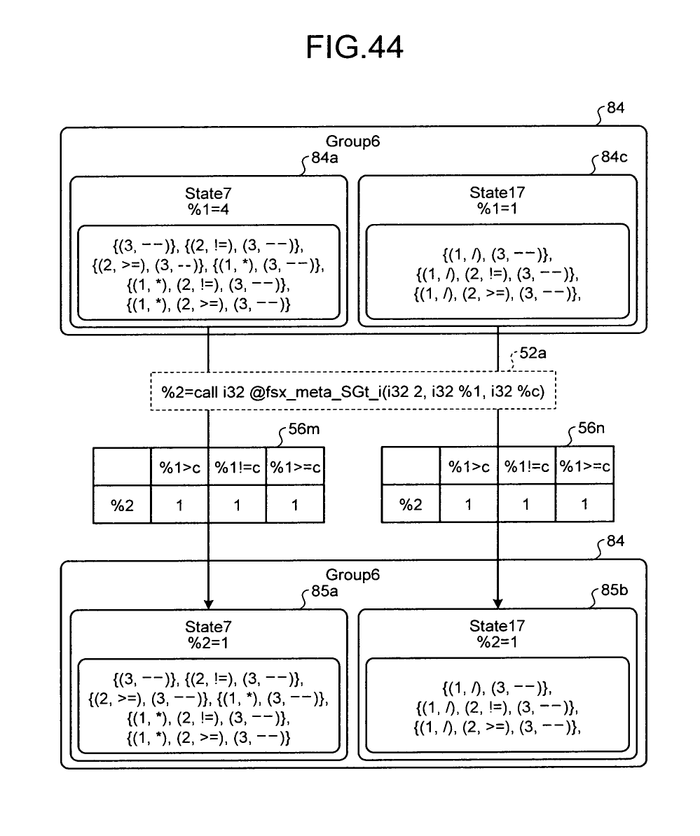

In FIG. 44, the state 84a is evaluated with respect to the command 52a. The register value “%2” in the command 52a is a value corresponding to a mutant of the operator “>” as illustrated in a table 56m. In this case, in the command 52a, a mutation descriptor “{}” and mutation descriptors with the mutation ID of “2” among mutation descriptors in the state 84a are evaluated. Here, each of “%1>c”, “%1!=c”, and “%1>=c” has the register value “%2” of “1”, that is, the same result. Therefore, in FIG. 44, the state ID “State7” is updated with respect to “%2=1” and a state 85a is obtained.

The state 84c is evaluated with respect to the command 52a. The register value “%2” in the command 52a is a value corresponding to a mutant of the operator “>” as illustrated in a table 56n. In this case, in the command 52a, mutation descriptors with the mutation ID of “2” among mutation descriptors in the state 84c are evaluated. Here, each of “%1>c”, “%1!=c”, and “%1>=c” has the register value “%2” of “1”, that is, the same result. Therefore, in FIG. 44, the state ID “State17” is updated with respect to “%2=1” and a state 85b is obtained. The state 85a and the state 85b have the command 52a that is a command without an adverse effect, so that they are classified into the group 84.

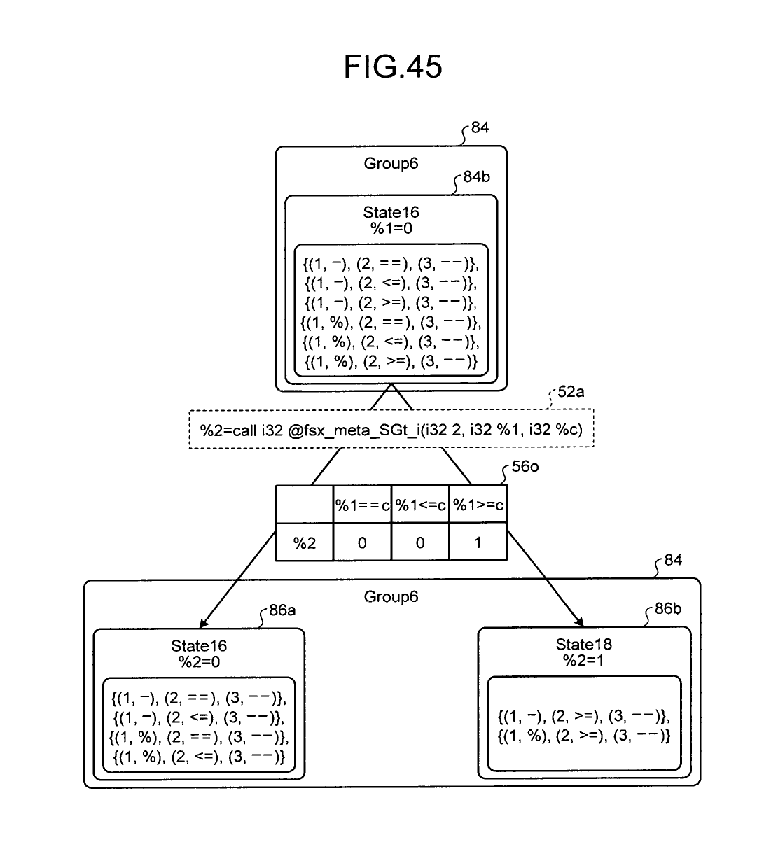

In FIG. 45, the state 84b is evaluated with respect to the command 52a. The register value “%2” in the command 52a is a value corresponding to a mutant of the operator “>” as illustrated in a table 56o. In this case, in the command 52a, mutation descriptors with the mutation ID of “2” among mutation descriptors in the state 84b are evaluated. Here, each of “%1==c” and “%1<=c” has the register value “%2” of “0”, that is, the same result. Therefore, in FIG. 45, the state ID “State16” is updated with respect to “%2=0” and a state 86a is obtained. Similarly, a state 86b with a state ID “State18” is generated with respect to “%2=1”. The state 86a and the state 86b have the command 52a that is a command without an adverse effect, so that they are classified into the group 84.

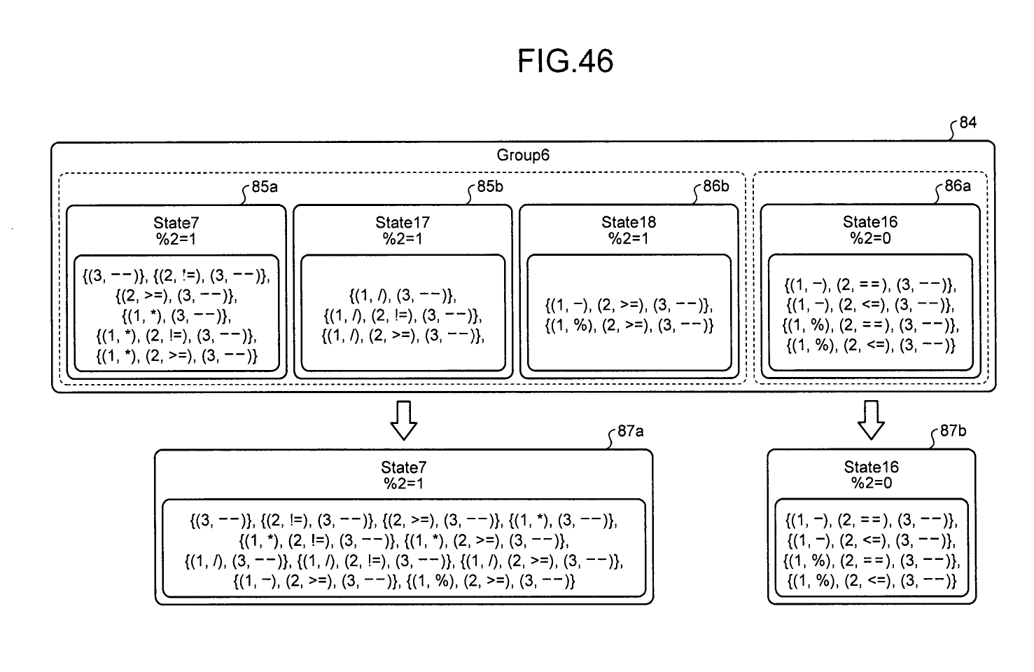

In FIG. 46, in the group 84, the states having the same calculation result of the register value “%2” are merged. In FIG. 46, the state 85a, the state 85b, and the state 86b are merged, the state ID “State7” is updated, and a state 87a is obtained. Similarly, in FIG. 46, there is no state to be merged with the state 86a, so that the state ID “State16” is updated as it is and a state 87b is obtained. The state 87a finally becomes an infinite loop and is therefore timed out. Furthermore, the state 87b exits the while statement, returns “−1”, and is terminated.

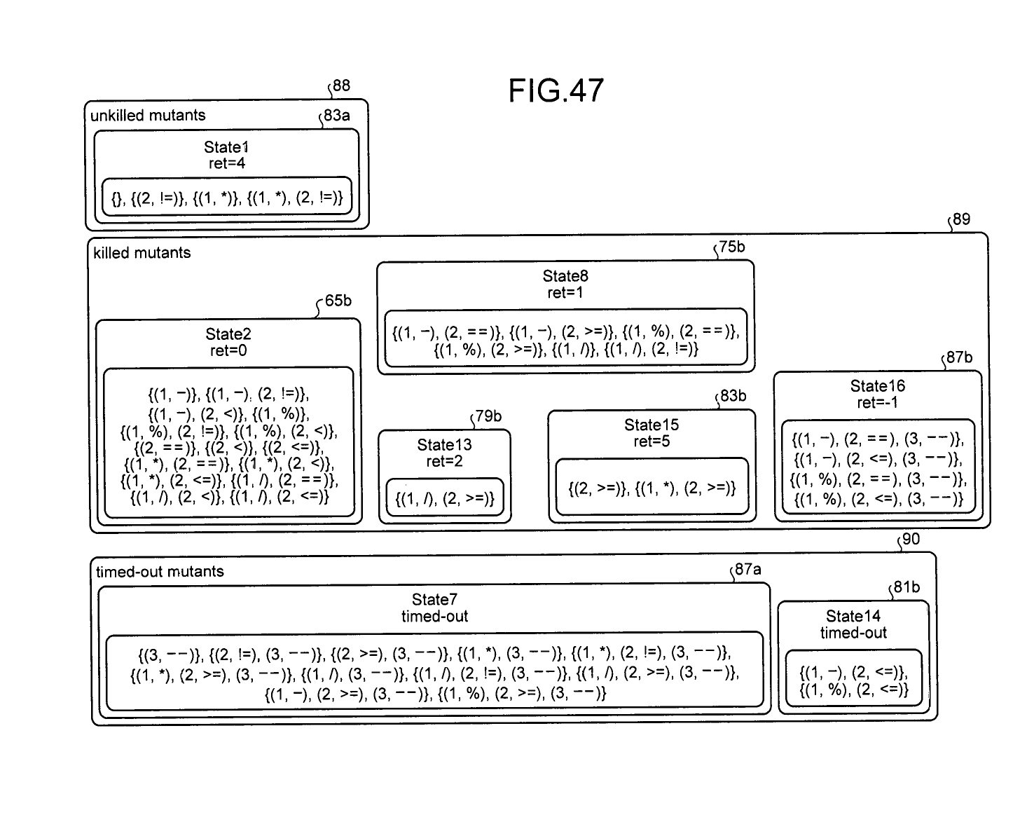

FIG. 47 is a diagram for explaining an example of assignment of each state. As illustrated in FIG. 47, in the specific example, the state 83a with the state ID “State1” is assigned to a group 88 indicating that mutants are not killed. That is, the group 88 includes states for which the test pass-fail is set to “Pass”. Furthermore, in the specific example, the state 65b with “State2”, the state 75b with “State8”, the state 79b with “State13”, the state 83b with “State15”, and the state 87b with “State16” are assigned to a group 89 indicating that mutants are killed. That is, the group 89 includes states for which the test pass-fail is set to “Fail”. Moreover, in the specific example, the state 87a with “State7” and the state 81b with “State14” are assigned to a group 90 that is timed out due to an infinite loop. Incidentally, the test pass-fail of the states in the group 90 can be set to either “Pass” or “Fail”; however, in this example, the test pass-fail is set to “Fail”, for example. As illustrated in the specific example, the analyzing apparatus 100 can execute a higher order mutation while reducing the number of states. Furthermore, the analyzing apparatus 100 can reduce the number of times of state splitting, as compared to the conventional technology.

As described above, the analyzing apparatus 100, when executing an intermediate code that is a compiled code in which an element in a source code is replaced with a metafunction that changes the element to a mutant, holds a set of mutation descriptors indicating a change in the mutant with respect to a mutation operation corresponding to the metafunction. The analyzing apparatus 100 evaluates a command of each of the mutation descriptors. The analyzing apparatus 100 selects one or more mutation descriptors having the same command evaluation result in the set of the mutation descriptors. The analyzing apparatus 100 calculates a direct product of the selected mutation descriptor and the mutation operation or a first state that is the set of the mutation descriptors before evaluation of the commands, thereby generating a second state. The analyzing apparatus 100, when evaluating a command of each mutation descriptor of the generated second state, if a plurality of the second states are present, bundles the second states into a single group and evaluates commands of the second states in the group in parallel. The analyzing apparatus 100 merges third states having the same evaluation result among third states that are based on the command evaluation results in the group. Consequently, it is possible to reduce the number of states of a higher order mutation.

Furthermore, the analyzing apparatus 100 merges the third states in the group while commands without adverse effects are continued. Consequently, it is possible to reduce the states, that is, the number of the states.

Moreover, if a command other than a command without an adverse effect appears, the analyzing apparatus 100 dissolves the group and evaluates the commands of the second states. Consequently, it is possible to prevent wasteful state splitting.

Furthermore, if a state returns to the first state or the second state through merging, the analyzing apparatus 100 does not perform merging. Consequently, it is possible to prevent repetition of splitting and merging.

Incidentally, while an LLVM bit code is used as an example of the intermediate code in the above-described embodiment, the code is not limited to this example. For example, it may be possible to use a Java (registered trademark) bytecode or the like that is executable on a JAVA VM.

The components illustrated in the drawings need not necessarily be physically configured in the manner illustrated in the drawings. In other words, specific forms of distribution and integration of the apparatuses are not limited to those illustrated in the drawings, and all or part of the apparatuses may be functionally or physically distributed or integrated in arbitrary units depending on various loads or use conditions. For example, the compiler 132, the state managing unit 133, and the command evaluating unit 134 may be integrated with one another. Furthermore, the processes illustrated in the drawings need not necessarily be performed in the same order as described above, and the processes may be performed simultaneously or in different order as long as the processing contents do not contradict one another.

Moreover, all or part of various processing functions implemented by the apparatuses may be implemented on a CPU (or a micro computer such as an MPU or a micro controller unit (MCU)). Furthermore, all or part of various processing functions implemented by the apparatuses may, of course, be implemented on a program analyzed and executed by a CPU (or a micro computer such as an MPU or an MCU) or a hardware using wired logic.

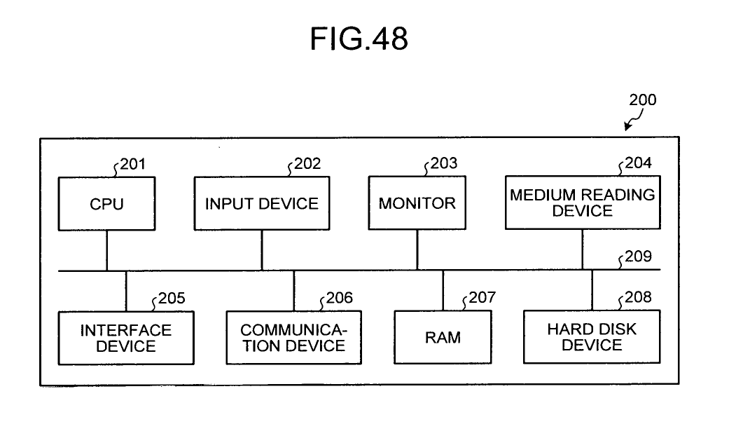

Incidentally, the various processes described in the above embodiment are implemented by causing a computer to execute a program prepared in advance. Therefore, an example of a computer that executes a program with the same functions as those of the above-described embodiment will be described below. FIG. 48 is a diagram illustrating an example of a computer that executes an analysis program.

As illustrated in FIG. 48, a computer 200 includes a CPU 201 that performs various kinds of operation processing, an input device 202 that accepts input of data, and a monitor 203. Furthermore, the computer 200 includes a medium reading device 204 that reads a program or the like from a storage medium, an interface device 205 for connecting to various devices, and a communication device 206 for connecting to other information processing apparatuses by wire or wireless. Moreover, the computer 200 includes a RAM 207 that temporarily stores therein various kinds of information, and a hard disk device 208. Furthermore, the devices 201 to 208 are connected to a bus 209.

The hard disk device 208 stores therein an analysis program having the same functions as the processing units such as the replacing unit 131, the compiler 132, the state managing unit 133, the command evaluating unit 134, and the output unit 135 illustrated in FIG. 1. Furthermore, the hard disk device 208 stores therein various kinds of data for implementing the command storage unit 121, the evaluation result storage unit 122, the execution state set storage unit 123, the test result storage unit 124, and the analysis program. The input device 202 accepts an input of various kinds of information, such as operation information or management information, from a user of the computer 200. The monitor 203 displays, for example, a result screen, a screen of the management information, and various screens for an administrator of the computer 200. The medium reading device 204 reads a source code, a test item, and a mutation operator list from the storage medium. The interface device 205 is connected to, for example, a printing device or the like. The communication device 206 has the same functions as those of the communication unit 110 illustrated in FIG. 1, is connected to a network (not illustrated), and exchanges various kinds of information with other information processing apparatuses, for example.

The CPU 201 reads each program stored in the hard disk device 208, loads the program on the RAM 207, and executes the program to perform various processes. Furthermore, the program can cause the computer 200 to function as the replacing unit 131, the compiler 132, the state managing unit 133, the command evaluating unit 134, and the output unit 135 illustrated in FIG. 1.

Incidentally, the above-described analysis program need not necessarily be stored in the hard disk device 208. For example, the computer 200 may read and execute a program stored in a storage medium that the computer 200 can read. Examples of the storage medium that the computer 200 can read include a portable recording medium, such as a CD-ROM, a DVD disk, or a USB memory, a semiconductor memory, such as a flash memory, and a hard disk drive. Furthermore, it may be possible to store the analysis program in a device connected to the public line, the Internet, a LAN, or the like, and cause the computer 200 to read the analysis program from the device and execute the analysis program.

It is possible to reduce the number of states of a higher order mutation.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A non-transitory computer readable storage medium having stored therein an analysis program causing a computer to execute a process comprising:
holding, when executing an intermediate code that is a compiled code in which an element in a source code is replaced with a metafunction that changes the element to a mutant, a set of mutation descriptors indicating a change in the mutant with respect to a mutation operation corresponding to the metafunction;
evaluating a command of each of the mutation descriptors;
selecting at least one mutation descriptor having a same command evaluation result from the set of the mutation descriptors;
calculating a direct product of the selected mutation descriptor and one of the mutation operation and a first state that'is the set of the mutation descriptors before evaluation of the commands, thereby generating a second state;
bundling, when evaluating a command of each mutation descriptor of the generated second state, if a plurality of the second states are present, the second states into a single group;
evaluating commands of the second states in the group in parallel; and
merging third states having a same evaluation result among third states that are based on the command evaluation results in the group.

2. The non-transitory computer readable storage medium according to claim 1, wherein the merging includes merging the third states in the group while commands without adverse effects are continued.

3. The non-transitory computer readable storage medium according to claim 1, wherein the evaluating the commands in parallel includes dissolving the group and evaluating the commands of the second states when a command other than a command without an adverse effect appears.

4. The non-transitory computer readable storage medium according to claim 1, wherein the merging includes not performing merging when a state returns to one of the first state and the second state through the merging.

5. An analytic method implemented by a computer, the analytic method comprising:
holding, when executing an intermediate code that is a compiled code in which an element in a source code is replaced with a metafunction that changes the element to a mutant, a set of mutation descriptors indicating a change in the mutant with respect to a mutation operation corresponding to the metafunction;
evaluating a command of each of the mutation descriptors;
selecting at least one mutation descriptor having a same command evaluation result from the set of the mutation descriptors;
calculating a direct product of the selected mutation descriptor and one of the mutation operation and a first state that is the set of the mutation descriptors before evaluation of the commands, thereby generating a second state;
bundling, when evaluating a command of each mutation descriptor of the generated second state, if a plurality of the second states are present, the second states into a single group;
evaluating commands of the second states in the group in parallel; and
merging third states having a same evaluation result among third states that are based on the command evaluation results in the group.

6. The analytic method according to claim 5, wherein the merging includes merging the third states in the group while commands without adverse effects are continued.

7. The analytic method according to claim 5, wherein the evaluating the commands in parallel includes dissolving the group and evaluating the commands of the second states when a command other than a command without an adverse effect appears.

8. The analytic method according to claim 5, wherein the merging includes not performing merging when a state returns to one of the first state and the second state through the merging.

9. An analyzing apparatus comprising:
a managing unit that, when executing an intermediate code that is a compiled code in which an element in a source code is replaced with a metafunction that changes the element to a mutant, manages a set of mutation descriptors indicating a change in the mutant with respect to a mutation operation corresponding to the metafunction;
a first evaluating unit that evaluates a command of each of the mutation descriptors;
a selecting unit that selects at least one mutation descriptor having a same command evaluation result from the set of the mutation descriptors;
a generating unit that calculates a direct product of the selected mutation descriptor and one of the mutation operation and a first state that is the set of the mutation descriptors before evaluation of the commands, thereby generating a second state;
a second evaluating unit that bundles, when evaluating a command of each mutation descriptor of the generated second state, if a plurality of the second states are present, the second states into a single group and evaluates the commands of the second states in the group in parallel; and
a merging unit that merges third states having a same evaluation result among third states that are based on the command evaluation results in the group.

10. The analyzing apparatus according to claim 9, wherein the merging unit merges the third states in the group while commands without adverse effects are continued.

11. The analyzing apparatus according to claim 9, wherein the second evaluating unit evaluates the commands in parallel includes dissolving the group and evaluating the commands of the second states when a command other than a command without an adverse effect appears.

12. The analyzing apparatus according to claim 9, wherein the merging unit does not perform merging when a state returns to one of the first state and the second state through the merging.
